(19) United States
(12) Patent Application Publication
(10) Pub. No.: US 2007/0273140 A1
(43) Pub. Date: Nov. 29, 2007

(54) Bound Printed Matter Comprising Interlaced Images and Decoders for Viewing Changing Displays of the Images

(76) Inventor: Itzchak Bar-Yona, Rosh Ha'Ayin (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/560,796

(22) PCT Filed: Jun. 16, 2004
(86) PCT No.: PCT/IL04/00547

§ 371 Date: Feb. 19, 2007

(30) Foreign Application Priority Data
Jun. 17, 2003 (IL) 156491
Jun. 17, 2003 (IL) 156493
Jun. 17, 2003 (IL) 156492
Aug. 28, 2003 (IL) 157655
Sep. 3, 2003 (IL) 157735

(51) Int. Cl. B42D 1/00

(52) U.S. Cl. 281/15.1

(57) ABSTRACT

The present invention relates to the field of printing and bound printed matter such as books, calendars, catalogs, and magazines. The invention provides printed matter bound printed matter and calendars on which are printed interlaced images, decoders for individually viewing the basic images of which the interlaced images are comprised, and methods based on lenticular technology of illustrating printed matter with changing displays.

### FIELD OF THE INVENTION

The field of the present invention is that of printing and bound printed matter such as books, calendars, catalogs, and magazines. In particular the invention is directed towards bound printed matter and calendars illustrated with changing displays based on lenticular technology.

### BACKGROUND OF THE INVENTION

Illustrations have always been an important addition to printed matter. Traditionally illustrations serve a variety of functions, such as decoration, increasing reader interest, clarifying, and supplementing the written text. Beginning with the hand illustrated manuscripts of the Middle Ages and up to the present time, many techniques have been developed to enhance the effectiveness of the illustrations provided.

In the majority of cases, the illustrations are two dimensional images printed along with the text and are often more effective in providing information than the printed word. However, even a series of two dimensional “still” pictures placed side-by-side can not effectively illustrate the motion of an object or the interaction between several objects in a concise manner that allows the reader to easily understand, in a single glance, the effects related to such motion.

The problem of creating a changing display on the printed page, i.e. showing more than one image in the same location on the page, for example to give the illusion of motion, has been approached with a limited amount of success by various techniques. One approach, a mechanical one, is the many variations of the familiar “pop-up” book for children.

A different approach, based on the use of simple optics, is taken by the inventor of U.S. Pat. No. 4,757,580, entitled “Peek-in Story Book”. In a first embodiment described in this patent, “. . . predetermined pages of the story book are provided with apertures aligned with transparencies and optics associated therewith so that the viewer can observe the scene being depicted on a transparency by looking through the aperture on the page.” While the invention described in this patent is intended to supplement the picture printed on the page by allowing the reader to see another scene (for example the interior of a room) by looking through an aperture or apertures (for, example in a window of the room) in the printed picture, it is clear that some limited sense of motion could be achieved by proper chose of transparencies and apertures. In a second embodiment of U.S. Pat. No. 4,757,580, “. . . the fixed transparency is replaced by a film reel rotatable by means of a crank so that a plurality of scenes can be observed through each aperture of the book.” The method of this embodiment is much more suited than that of the first embodiment for illustrating motion effects but both suffer from the same major drawbacks. Amongst these drawbacks are: the limited number of scenes that can be inserted in a given book as a result of the physical size of the lenses, etc.; the aperture must be created from the back of the book to the page from which the scene on the transparency is to be viewed so that if a transparency is to be viewed on the first page, the aperture must be created throughout all the pages and the story must be constructed such that it makes sense to see this same image on every succeeding illustrated page of the book. These two difficulties in themselves are enough to indicate that the invention can only be applied to books with a very limited number of illustrated pages. Additionally, the difficulty and accompanying cost of planning and constructing a book according to the method of the invention makes it practical only for books aimed at a very limited market. It is to be noted that other methods, such as the “pop-up” books suffer from some or all of these same drawbacks.

Yet another approach to providing book illustrations with the illusion of motion is the familiar, so called, “flip book”. Such a book is described in published International Patent Application WO 00/24593. A sequence of pictures, such as frames of a video clip, are printed, one frame per page, on consecutive pages of the book. When the pages are “flicked” the video clip is replayed for the viewer. The method suffers from several disadvantages the most serious of which is that the relatively large number of frames needed to produce the effect means that only a limited number of such illustrations can be provided in a given book. Additionally, the pictures for a particular scene must be located at the same position on the consecutive pages and be of identical size. If the scene is described in the text on a given page and consists of several frames, then pausing to view the scene causes a discontinuity in reading the text, a disadvantage, for example, in the case of textbooks. Finally, the quality of the results depends on the “flip rate” of the reader. The number of images to portray a given scene is determined by the book publisher on the basis of “an average flick rate of an average user”, however it isn't clear how the scene would look to a “non-average” user.

Wall calendars generally serve as decorative items in a room combining the function of providing attractive wall covering with the practical function of prominently displaying such useful information as the date, day of the week, references to historical events that took place on a given date in the past, etc.

By far the predominant use of wall calendars is connected with the advertising industry. For advertising purposes the illustrations on the calendar must be both eye-catching, to attract attention to the advertiser's message; aesthetic, so that persons will be willing to hang them on their walls; and interesting, so that people will repeatedly look at them over the relatively long period of time they hang on the wall. Lenticular technology is capable of providing effects that will satisfy these requirements in a way that they are not satisfied in present day calendars.

A most promising approach to the introduction of illustrative effects that are unobtainable using presently available methods is to make use of the lenticular technology that has been developed primarily for the advertising industry. Lenticular imaging is used to provide a variety of effects—flip, morph, zoom, motion, depth, and virtual 3-d—all of which provide much more information and interest than can be provided by conventional two dimensional illustrations used to illustrate books, magazines, catalogues, and other types of printed matter on any suitable indicia carrier. The technology of lenticular imaging is well known in the printing and advertising industries; however, to date, this technology has not been adapted for use with bound printed matter. The reasons for this are technical and economic.

The following simple example illustrates a few of the main problems. Suppose it were desired to publish a magazine having 200 pages with lenticular imaging on 100 pages. The pages comprising lenticular images will have a lens sheet attached on top of the printed interlaced images and the resulting page will have a thickness of about 300 microns as compared to regularly printed pages having a thickness of about 60 microns. The resulting magazine, containing the lenticular images, would be about 36 mm thick as compared to the 12 mm thickness of a conventional magazine. In addition to the cost of producing a magazine comprising 100 lenticular sheets, the thickness and weight of this magazine greatly increase storage and distribution costs make it unwieldy to carry and read. Another problem is that the viewing quality of most of the effects provided with lenticular technology is vastly improved by use of dynamic systems, i.e. causing repetitive relative motion between the print and the lenses. The static systems, such as those described with reference to the example hereinabove, depend on changing the angle of vision to see the separate lenticular images. Since it is difficult to accurately control the uniformity of the change of viewing angle, the lenticular effect is diminished especially when trying to create illusions of motion, which require a relatively large number of uniformly spaced (in time) flips per scene. To date, it has not been shown how dynamic systems can be created for viewing interlaced images printed on the pages of a book or magazine.

It is therefore an object of the present invention to provide bound printed matter illustrated with lenticular displays created on its pages, said pages also optionally comprising text and/or conventional illustrations.

It is another object of the present invention to provide methods of creating and viewing, with a constant, pre-determined flip rate, illustrations comprising dynamic lenticular displays printed on the pages of bound printed matter.

It is yet another purpose of the present invention to provide bound printed matter that is not limited in the number of pages that contain illustrations comprised of changing lenticular displays.

It is a further purpose of the present invention to provide bound printed matter, illustrated with illustrated by changing displays, which can be produced at a cost substantially equal to that of printed matter produced and illustrated with conventional images.

It is a still further purpose of the present invention to provide bound printed matter, illustrated with changing displays, which are virtually impossible to reproduce.

It is an additional purpose of the present invention to provide bound printed matter containing masked images that are virtually unviewable without a decoder device to decode them.

It is another object of the present invention to provide a method of utilizing lenticular technology to create wall calendars comprising changing displays.

It is a further purpose of the present invention to provide wall calendars illustrated with changing displays that can be produced at a cost substantially equal to that of wall calendars illustrated with conventional static images.

It is another object of the present invention to provide a decoder for successively viewing the basic images of which an interlaced image printed on an indicia carrier.

It is another object of the present invention to provide a decoder for successively viewing the basic images of which an interlaced image printed on a page of bound printed material is composed, said pages also optionally comprising text and/or conventional illustrations.

It is yet another object of the present invention to provide a method of viewing illustrations comprising dynamic lenticular displays printed on an indicia carrier.

Further purposes and advantages of this invention will appear as the description proceeds.

### SUMMARY OF THE INVENTION

In a first aspect the present invention is directed towards providing bound printed matter comprising one or more interlaced images printed on one or more pages. The interlaced image(s) comprise two or more basic images which are successively viewable by means of a decoder. The decoder comprises at least one lenticular panel, having one planar surface and an array of lenticular lenses on the other surface, and means for moving the lenticular panel relative to the image.

The term “interlaced images printed on one or more pages”, as used herein, is meant to include any interlaced image provided on a substrate (indicia carrier), whether it has been printed directly on a page of the bound printed matter, or has been added to it after printing and/or binding, e.g., by adding a sticker to an existing page, or by placing the interlaced image on top of a page and/or of an existing image in any other way and by any other means.

Stickers comprising an interlaced image to be used as described hereinabove are also meant to be encompassed by the present invention.

The printed matter may further comprise reference marks for alignment created on the pages and the decoder may further comprise means for aligning the panel with the reference marks

The pitch of the lines of print in the interlaced image of the bound printed matter may be constant or variable.

In a second aspect the present invention is directed towards providing, in combination, printed matter and a decoder. The printed matter comprises one or more interlaced images printed on one or more of its pages. Each of the interlaced image(s) comprises two or more basic images. The decoder, for successively viewing the basic images, comprises at least one lenticular panel and, optionally, means for moving the lenticular panel relative to the image. The lenticular panel has one planar surface and an array of lenticular lenses on the other surface. The printed matter can further comprise reference marks for alignment created on the pages. The decoder can further comprise means for aligning the lenses with the reference marks on the page.

In a third aspect the present invention is directed towards providing a method for distributing masked images. The method comprises printing an interlaced image on a substrate and decoding the interlaced image using a decoder comprising at least one lenticular panel. The lenticular panel has one planar surface and a linear array of lenticular lenses on the other surface and can be movable relative to the interlaced image.

In a fourth aspect the present invention is directed towards providing a decoder for viewing the basic images comprising an interlaced image printed on a page of bound printed matter. The decoder comprises:
at least one lenticular panel, having one planar surface and a linear array of lenticular lenses on the opposite surface;
optionally means for aligning the lenticular panel with the interlaced image printed on the page; and
optionally means for moving the lenticular panel relative to the printed interlaced image.

The decoder of the invention may further comprise a rigid frame comprising either one or two wings. The array of lenses may be moveably attached to the rigid frame and the decoder may further comprise means for moving the lenticular panel relative to the rigid frame.

The array of lenticular lenses may be essentially linear. The array of lenticular lenses may have a pitch that is either constant or variable. The front surface of the lenticular sheet may be coated with an anti-reflection layer.

The decoder may further comprise means for aligning the rigid frame with the interlaced image printed on the page. The alignment means may be chosen from the group comprised of, but not limited to the following:
printed guide lines viewed through the lenticular sheet;
printed dots on the page viewed through holes in the decoder;
pins protruding from the bottom of the decoder that enter holes in the pages;
magnets on the decoder that are attracted to marks printed on the page using ink containing metallic particles; and
an electric circuit on the decoder comprising LEDS and gaps in the wiring, said gaps being closed by appropriately placed conducting elements on the page.

In a preferred embodiment of the decoder of the invention, the upper wing of the frame of comprises a lenticular panel and means for moving the lenticular panel relative to the frame and the lower wing of the frame comprises a planar firm surface. The page is inserted between the lenticular sheet and the planar firm surface. The lower wing can further comprise a resilient mat.

The decoder of the invention can further comprise a time-release mechanism for controlling the motion of the lenticular panel relative to the rigid frame.

A preferred embodiment of the decoder of the invention comprises means for slidably displacing the lenticular panel over the interlaced image. The means to slidably displace the panel preferably comprise roller means. The roller means comprise a rotatable axis supported by two supports at its extremities and provided with contact points on its surface to create a frictional force with the surface of the pages upon rotation, thereby to cause a displacement of the panel. The contact points are made of a high-friction material and can be, for example, ring-like in shape or non continuous protrusions on the axis. It is preferred that the roller means be actuatable by hand, preferably by the pressure of a finger.

In a preferred embodiment of the decoder of the invention, the means for establishing and maintaining the required alignment between the interlaced image and the lenticular panel comprise one or more contact surfaces located along the length of the outer edge of the panel and projecting downward from its lower surface. The contact surfaces are selected from static or moving surfaces or a combination thereof. In preferred embodiments of the invention the surface is a page of bound printed material.

The decoder may further comprise displacement means for slidably displacing the lenticular panel relative to the interlaced image.

The contact surface may be stationary or rotating. If it is stationary, it may be formed from a single long strip or from two or more tabs.

The displacement means to slidably displace the lenticular panel relative to the interlaced image may comprise roller means. The roller means may comprise a wheel attached to a rotatable axis which is supported by supports at its extremities. The wheel has a diameter such that, when the lower planar surface of the decoder is in intimate contact with the surface containing the interlaced image, the outer circumference of the wheel is also in contact with the surface. At least the outer circumference of the wheel is preferably provided with a suitable outer surface such that, upon rotation of the wheel, a frictional force is created between the wheel and the surface on which the interlaced image is printed. A suitable outer surface can be a layer of rubber or an array of small protrusions.

In another aspect the present invention provides a method of using this embodiment of the decoder to successively view the basic images of which an interlaced image printed on a surface is composed. The method comprises the following steps:
a. placing the decoder over the interlaced image on the surface;
b. pushing the decoder against the surface so that the means for establishing and maintaining the required alignment between the interlaced image and the lenticular panel are in intimate contact with the edge of the surface; and
c. slidably displacing the lenticular panel relative to the interlaced image.

The lenticular panel can be slidably displaceable by manually sliding the decoder on the surface or by activating the displacement means. In a preferred embodiment of the invention the displacement means for slidably displacing the lenticular panel relative to the interlaced image are activated by rotating a wheel attached to the decoder.

In another aspect the present invention provides a wall calendar comprising one or more interlaced images printed on its pages, a decoder, and a combination of the two. The interlaced images comprise two or more basic images and the basic images are successively viewed by means of the decoder. The decoder comprises:
a rigid back part attachable to a substantially vertical surface;
a lenticular panel, having one planar surface and an array of lenticular lenses on the other surface, moveably attached to said back part;
optional means for moving said lenticular panel relative to said back part;
means for maintaining said lenticular panel in alignment with said lines of print; and
means for holding said lines of print and said lenticular panel in parallel planes separated by a distance essentially equal to the focal length of said lenses.

The means for moving the lenticular panel relative to the back part can be a motor having an eccentric cam on its shaft. The motor is actuated by an energy source chosen from the following group:
1. battery;
2. solar energy; and
3. electric mains power.

The pitch of the lenses on the lenticular panel of the decoder and of the lines of print in the interlaced image of the wall calendar of the invention can be either constant or variable. In a preferred embodiment of the invention, the front surface of the lenticular sheet is coated with an antireflection layer in order to allow improved viewing of the images

All the above and other characteristics and advantages of the invention will be further understood through the following illustrative and non-limitative description of preferred embodiments thereof, with reference to the appended drawings.

### BRIEF DESCRIPTION OF THE DRAWINGS

FIGS. 1 to 5 demonstrate one method of creating an interlaced image comprised of two separate basic images;

FIGS. 6A to 6C schematically show the optical requirements for viewing the basic images;

FIG. 7 schematically shows the basic configuration of the printed matter and decoder according to the present invention;

FIGS. 8A to 8E schematically show a preferred method of printing the guide lines on the page;

FIG. 9 schematically shows a simple embodiment of the decoder of the invention;

FIGS. 10A to 10C schematically show perspective, top, and cross sectional views of a preferred embodiment of the decoder of the invention;

FIGS. 11A and 11B schematically show how the decoder of FIGS.

10A to 10C is attached to the page;

FIG. 12 schematically shows an embodiment of the decoder of the invention comprising a resilient mat;

FIGS. 13, 14A, 14B, and 15 schematically show another preferred embodiment of the decoder of the invention;

FIG. 16 schematically shows an embodiment of the printed matter and decoder according to the present invention;

FIGS. 17A to 17C schematically show perspective, top, and cross sectional views of a preferred embodiment of the decoder of the invention;

FIGS. 18A and 18B schematically show how the decoder of FIGS. 17A to 17C is attached to the page;

FIG. 19 schematically shows an embodiment of the decoder of the invention comprising a resilient mat;

FIG. 20 schematically shows a book and a decoder according to the present invention;

FIG. 21 is a top view, showing a preferred embodiment of the decoder of the invention with the upper wing removed in order to reveal internal details of the device;

FIG. 22 is a cross sectional view in a plane perpendicular to the view of FIG. 21;

FIG. 23 is a top view, showing another preferred embodiment of the decoder of the invention with the upper wing removed in order to reveal internal details of the device;

FIG. 24 is a cross sectional view in a plane perpendicular to the view of FIG. 23;

FIGS. 25 and 26 are enlarged views of selected sections of FIGS. 23 and 24;

FIGS. 27, 28A to 28C, and 29 schematically show a preferred embodiment of the decoder of the invention;

FIGS. 30A, 30B, and 30C show schematically a preferred embodiment of the decoder of the invention comprising means for slidably displacing the lenticular panel over the interlaced image;

FIG. 31 schematically show a page of bound printed matter such as a book, catalog, or magazine according to the present invention;

FIGS. 32A, 32B, and 32C are top, cross-sectional, and side views, respectively, showing schematically a preferred embodiment of a decoder of the invention;

FIGS. 33A, 33B, and 33C are top, cross-sectional, and side views, respectively, showing schematically another preferred embodiment of a decoder of the invention; and

FIGS. 34A to 34C schematically show, respectively, front, cross-sectional, and exploded views of the calendar and decoder of the invention.

### DETAILED DESCRIPTION OF PREFERRED EMBODIMENTS

The following definitions are used in this specification:
The words “panel”, “sheet”, and “film” are used interchangeably to refer to a transparent substrate whose height is much less than its width or length and whose two principal planar faces are essentially parallel.
The terms “lenticular panel”, “lenticular sheet”, and “lenticular film” are used interchangeably to refer to a panel, sheet, or film comprising an array of lenticules created on one of its principal faces.
An “interlaced image” is a printed composite image made by dividing two or more different pictures into “strips”, also referred to as “lines”, and arranging the strips into a predetermined pattern and, optionally, performing other operations on the arrangement of strips before printing the arrangement on a suitable substrate.
An indicia carrier is the substrate on which the interlaced image is printed. The indicia carrier can be composed of any suitable material such as paper or plastic sheet or film, it can be a single sheet or a page bound in a book or magazine. In the case of static displays, the indicia carrier can be the planar side of the lenticular panel opposite the array of lenses.
A “line” of print of the interlaced image is a line printed on the indicia carrier. Each line of print of the interlaced image contains one strip from each of the basic images and is the width of one of the lens on the array on the lenticular panel.
The term “basic image” is used to refer to one of the two or more pictures that are sliced into strips to create the interlaced image.
The term “masked image” refers to all of the strips in the interlaced image related to one of the basic images.
A “decoder” is a device used to view the individual masked images in the interlaced image. i.e. to reveal the basic images.
A changing display on a printed page refers to showing more than one image in the same location on the page, for example to show a series of “still” images or to give the illusion of motion.
A static display is a changing display based on lenticular technology wherein there is no relative motion between the indicia carrier and the lens sheet and the basic images are revealed by changing the viewing angle of the reader.
A dynamic display is a changing display based on lenticular technology wherein the basic images are revealed by causing relative motion between the indicia carrier and the lens.

As is well known to experienced persons, in practice an interlaced image is created digitally using digital cameras and computers guided by appropriate software and then stored in the computer's memory to be eventually printed on a suitable substrate. The methods, hardware, and software required for producing and printing interlaced images are well known in the art and will not be discussed in detail hereinbelow for reasons of brevity.

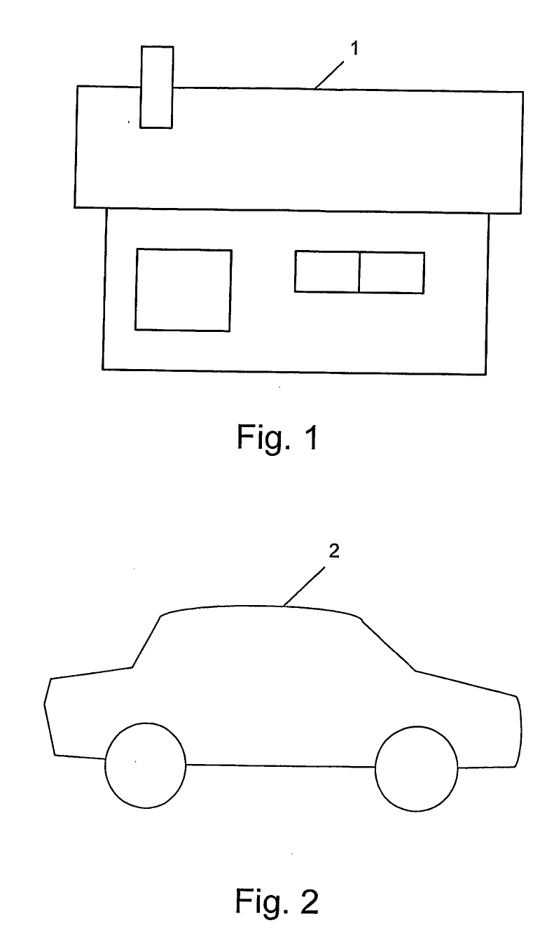

In order to appreciate the basic requirements of creating a lenticular display, one known method of creating an interlaced image comprised of two separate basic images is demonstrated in FIGS. 1 to 5.

In FIG. 1 is shown one of the basic images, in this case house 1, and in FIG. 2 the second basic image, automobile 2. The images in FIGS. 1 and 2 are recorded graphically or with a digital camera and stored in the memory of a computer.

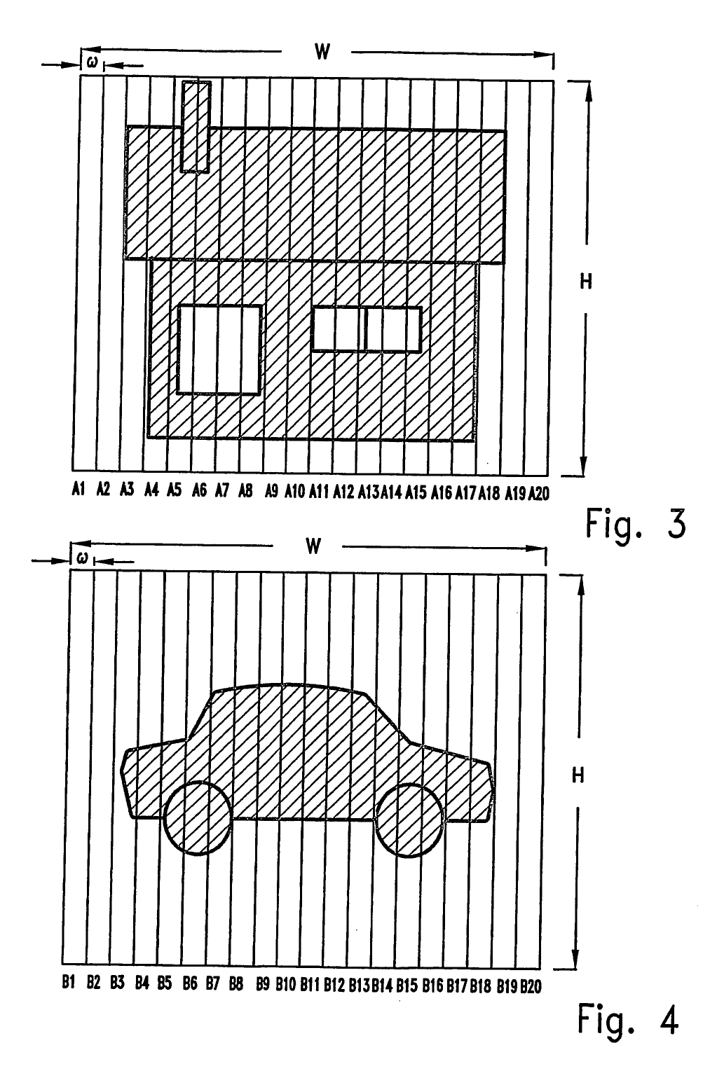

In the next step in creating the interlaced image, shown in FIGS. 3 and 4, the sizes of both basic images are adjusted resulting in two images having equal height H and width W. Each of the basic images is then electronically cut into n equal strips, referred to as “lines”. Each of the resulting n lines for each of the images has height H and width w, where w=W/n is defined as the pitch of the interlaced image. In the present example, for simplicity and clarity, n is chosen to be 20 and the lines of images 1 and 2 are labeled respectively A1-A20 and B1-B20.

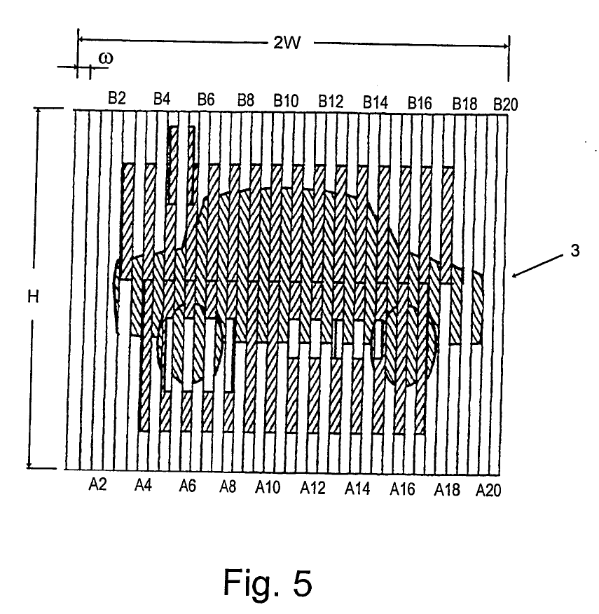

Following instructions provided by the software, the computer then merges the information contained in the two basic images into a single combined image (computer file) by arranging the forty strips of width w in the order A1, B1, A2, B2, . . . . A20, B20 to form the combined image 3, shown schematically in FIG. 5. Image 3 has the same height H as each of the original images and width 2W.

Finally, the width of the combined image is compressed uniformly to W, in order to retain the proper proportions in the images that will be observed when looking at the interlaced image through the lenticular sheet. The interlaced image is stored as a file in a computer and is eventually printed in the proper location in the book using conventional means.

Additionally other methods of interlacing are well known in the art and can be modified, mutatis mutandis, to the requirements of the present invention.

In order to be able to see the basic images that have been interlaced and printed on the page, the interlaced, image is viewed through an array of lenticular lenses. The lenses can be of many types and shapes including linear, spherical, cylindrical, Fresnel, etc. They type is chosen because the lenses can be arranged with the same geometrical configuration as the lines of printing and to be suitable for the particular application. For example, an array of linear cylindrical lenses is used for viewing the interlaced images of the type shown in FIG. 5. If the requirements listed hereinbelow for a lenticular display are met, then the basic images are alternately displayed by changing the viewing angle of the interlaced image through the lenses (a static display) or by causing relative motion, in a controlled manner (a dynamic display), between the interlaced image and the lenses.

The fundamental requirements of a lenticular display are the following:
1. The pitch of the interlaced image must be essentially equal to the pitch of the lenses.
2. The distance between the interlaced image and the lenses must be constant and essentially equal to the focal length of the lenses.
3. Exact alignment between the interlaced image and the array of lenses must be established and maintained during the relative motion between the lenses and printing; e.g., in the case of the interlaced images shown in the FIG. 5, the long axis of the printing on the indicia carrier must be essentially parallel to the long axis of the cylindrical lenses.

These requirements and methods of satisfying them are well known in the art and will not be further discussed herein for reasons of brevity.

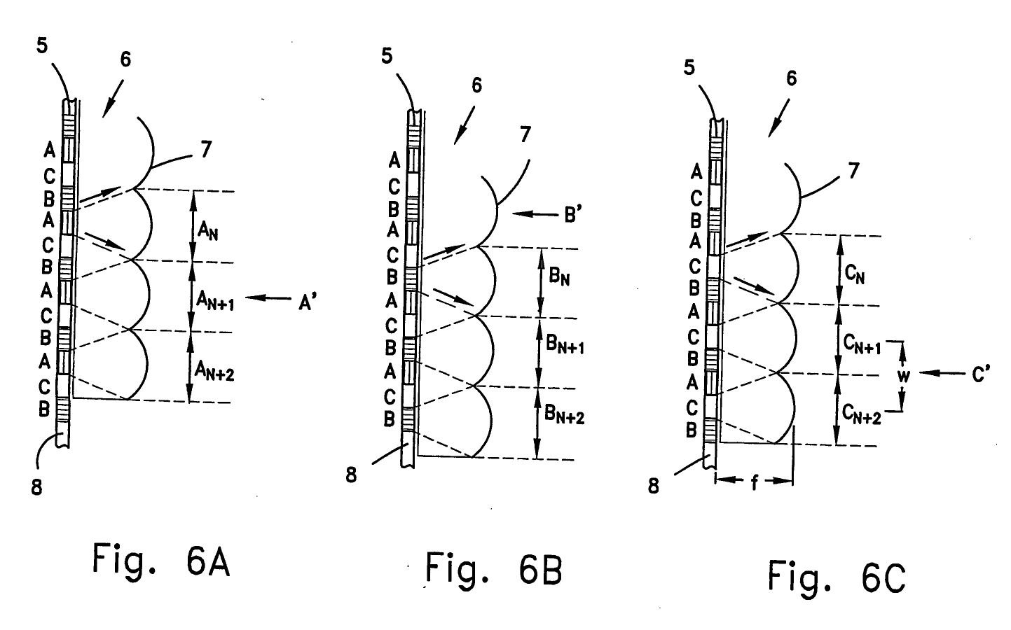

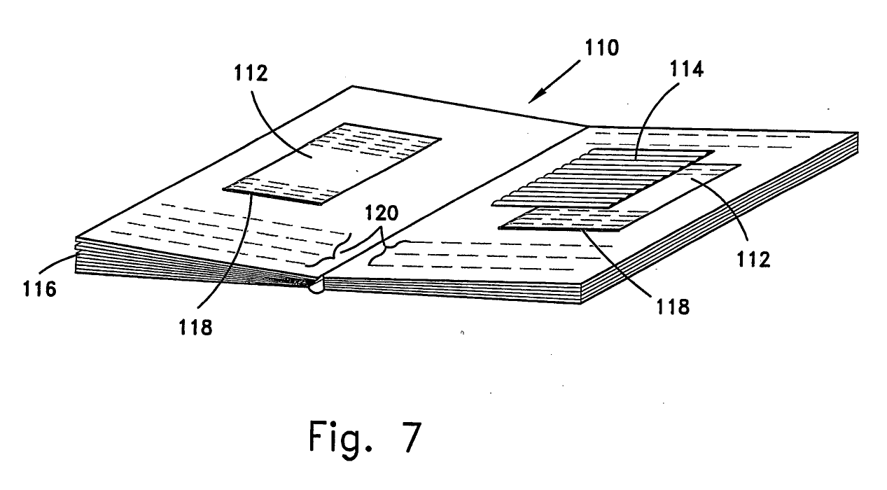

FIGS. 6A to 6C schematically show the optical requirements for viewing the basic images. Lenticular lens array 7 is created on the top face of transparent sheet 6 and the interlaced image 5 is printed on the page 8. The distance between the printing and the top of the lenses (designated in the figures by the letter f) is constant and essentially equal to the focal length of the cylindrical lenses that comprise the array. The interlaced image, in this case, is comprised of three basic images A, B, and C. The pitches, w, of both the printed interlaced image and of the lenses are equal. Arrows A′, B′, and C′ indicate how, at different positions of the lenticular sheet relative to the lines of printing on the page, looking through the lenses in a direction essentially perpendicular to the page will alternatively reveal basic images A, B, and C to the observer as the relative motion occurs. The dashed lines in FIGS. 6A to 6C show the paths of the rays that pass through the edges of each of the lenses and are focused on the printing and the unlabeled arrows the direction of the light rays reflected from the printing. The bold lettering Aₙ, Aₙ₊₁, etc. indicates the image of line Aₙ, etc. of the interlaced image (refer to FIG. 5) that is viewed through the nth lens of the array.

As described hereinabove, the pitch the lenses on the lenticular sheet is constant and equal to that of the lines of printing if the decoder is to be able to decode the images. To make it even more difficult to make unauthorized reproductions of the illustrations, interlaced images having variable pitch and matching lenticular sheets can be used. According to this method, the value of the basic pitch is shifted in a predetermined fashion from one lens to an adjacent lens in at least a part of the array. The variation in pitch from one lens to the next is small such that it will not cause a noticeable localized distortion in the basic images of an interlaced image, having the basic pitch, viewed through the lenticular sheet. The variation in the width of two adjacent lenses can be up to 10% without causing distortion of the print, but it is preferred to keep the variation much smaller, on the order of 1%. The accumulated effect of a series of small variations in the pitch (known as the cumulative pitch) of the lenses however eventually results in a sufficient difference between the pitch of the lenses and the basic pitch of the lines of print of the interlaced image such that the first condition for a lenticular display listed hereinabove is violated. The maximum allowable difference between the cumulative pitch of the lenses and that of the printing, such that it is still possible to view the basic images, is defined as the tolerance of the basic pitch. The tolerance is dependent on the number of basic images and when this tolerance is exceeded it becomes impossible to view the basic images. The largest value of the tolerance is about 50% of the basic pitch, for the case of an interlaced image composed of two basic images.

Once the pattern of the variation in pitch from lens to lens has been decided upon the computer program used to produce the interlaced image is adjusted to vary the width of the lines of the interlacing in accordance with the variable pitch of the lenses on the lenticular sheet. When this is done, there is agreement at all points between the pitches of the lenses and the underlying printing and therefore the basic images can be viewed.

Thus a relationship has been established between the lens sheet and the interlaced image that must be satisfied if the basic images are to be viewed. Any type of pattern, random or according to a mathematical formula, can be used for varying the pitch, the only requirement being that the change from lens to lens is small and that the accumulated variation eventually lead to total cumulative pitch is greater than the tolerance of the basic pitch.

Any one who has in his possession, for example, a lenticular sheet, produced according to this method, will not be able to use it with a printed interlaced image having a constant pitch or even having a variable pitch created with a pattern different from that of the lenticular sheet. Additionally, reverse engineering to modify a print program to conform to a variable pitch lens sheet without knowledge of the rule governing the changes on the lens sheet is virtually impossible.

According to the present invention, interlaced images are printed directly on the pages of the book, along with ordinary illustrations and the text, as desired. An optical device, referred to for simplicity as a “decoder”, is provided to decode the masked images, i.e. to allow the basic images comprising the interlaced image to be individually observed and to create a changing display. The principal component of the decoder is a lenticular panel. In its basic form the decoder comprises a transparent panel that is placed on the page over the interlaced image and aligned with the lines of print to form a static display. In other embodiments the decoder further comprises a frame, various alignment means, and means to attach it to the page. By shifting the angle at which the interlaced image is viewed through the lenticular sheet the basic images are successively viewed and individual basic images or an effect of motion is achieved, i.e. a changing display has been provided on the page of the bound printed matter.

With the addition of means for moving the lenticular sheet relative to the frame and thus to the interlaced picture, so that the basic images are successively viewed and separate basic images or an effect of motion is achieved, i.e. a dynamic changing display is provided on the page of the bound printed matter. In a preferred embodiment of the invention, the front surface of the lenticular sheet is coated with an antireflection coating layer in order to allow improved viewing of the images. Other embodiments comprise means for attaching the decoder to the print, establishment and maintenance of alignment and spatial relationship between the print and the lenses, and various mechanisms for causing the relative motion.

Many different embodiments of the decoder can be devised for providing changing displays based on lenticular technology. The embodiments described hereinbelow are provided merely as examples to illustrate the invention and are not intended to limit the scope of the invention in any manner. Once the basic principle of the invention is understood, the skilled person will have no difficulty in suggesting alternative embodiments and to form a dynamic display in which the basic images are revealed by creating repetitative relative motion between the lenticular sheet and the interlaced image.

It is to be noted, that although reference is frequently made to books in this specification, the invention and word “book” is intended to apply to all forms of printed matter including, but not limited to, books, magazines, pamphlets, newspapers, calendars, etc. The invention can also be applied to non-bound printed matter. The printing can be on any suitable material such as paper, plastic, etc.

The basic configuration of the invention is schematically shown in FIG. 7. Printed on the pages 116 of book 110 are interlaced images 112. The interlaced images can be the size of an entire page or smaller, in which case they are printed on the page together with conventional text and illustrations 120, if desired. The basic images of which interlaced image 112 is comprised can be, for example, pictures of different objects, describe the steps in a process, or be the frames of an animated presentation. The decoder, comprising a lenticular panel 114 is placed upon the page on top of the interlaced image, aligned with the aid of guide lines 118 that are printed together with the interlaced image along one or more of its borders, and held in place by suitable means such as being manually pressed against the page or held to the page by reusable weak glue.

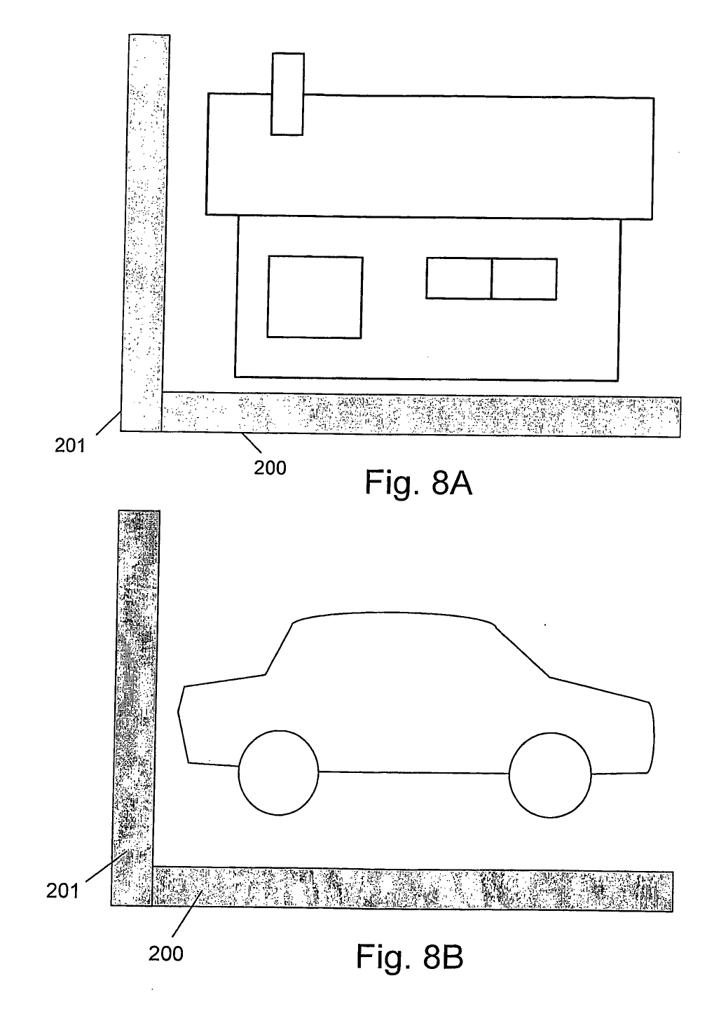

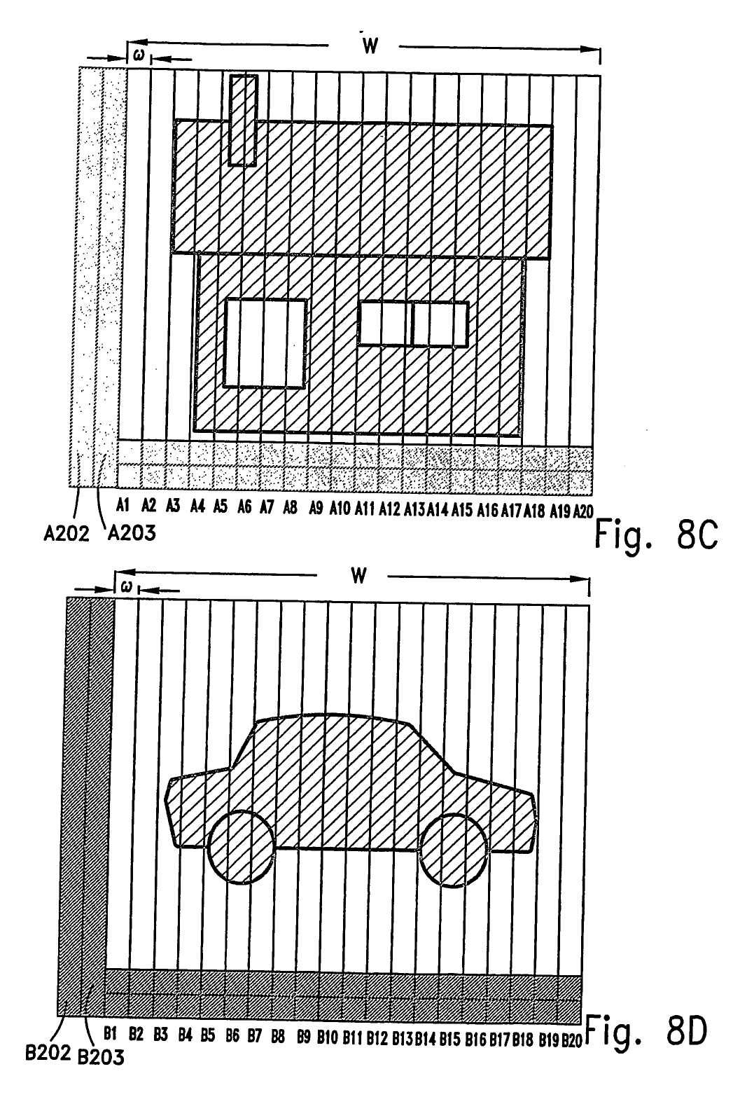

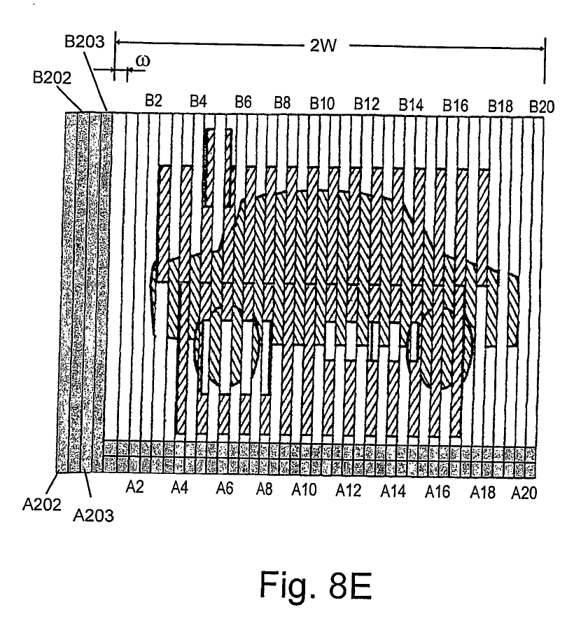

The alignment of the lines of printing in the interlaced image and the lens on the lenticular panel can be carried out in a variety of ways. The preferred method of printing the guide lines on the page is schematically shown in FIGS. 8A to 8E. During the printing process, a border 200, 201 is printed on one or more sides of the basic images 1, 2, as shown in FIGS. 8A and 8B. A different solid color is used to produce the borders of each basic image. During the interlacing process, as described hereinabove, the software slices the border into lines along with the rest of the basic image (For illustrative purposes border 201 is shown sliced into two lines 202, 203). Finally the interlaced image is formed and compressed as shown in FIG. 8E. The guide lines are viewed through the lenticular panel whose orientation on top of the interlaced image is shifted until a solid color is observed along the border of the interlaced image indicating correct alignment. If there is any misalignment then two or more colors will be seen at the border of the images. The border parallel to the lines of the interlaced image is used for alignment of the lenses with the print. The border perpendicular to the direction of the printing lines is used to test the pitch of the print relative to that of the lenses. If, for example, the paper on which the printing has been done has absorbed water or is in a very humid atmosphere, then the pitch will change. The paper can be dried, while observing the margin of the interlaced image to tell when the correct pitch has been attained. This method of determining the correct alignment is much easier to use than simply placing the decoder on the interlaced image and shifting it to look for the clearest image. This is because in all but the simplest of flip applications, the different basic images are so close to each other in appearance that it is virtually impossible to determine when a single clear image is seen.

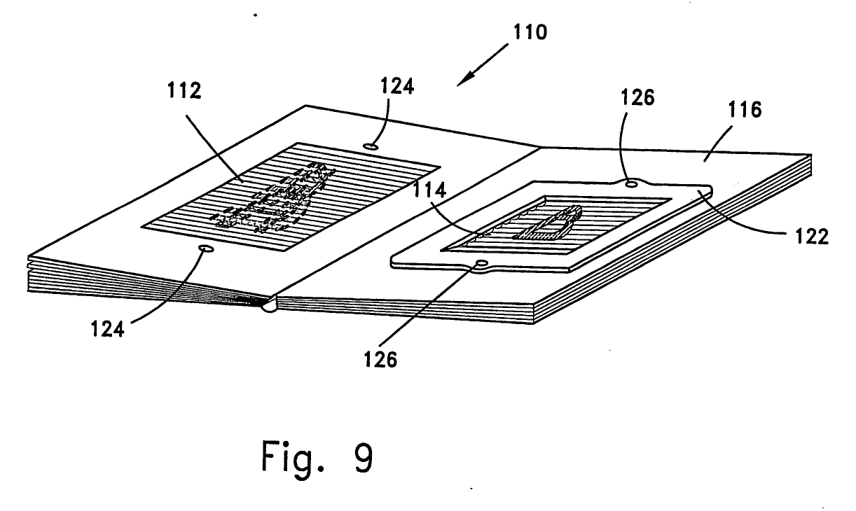

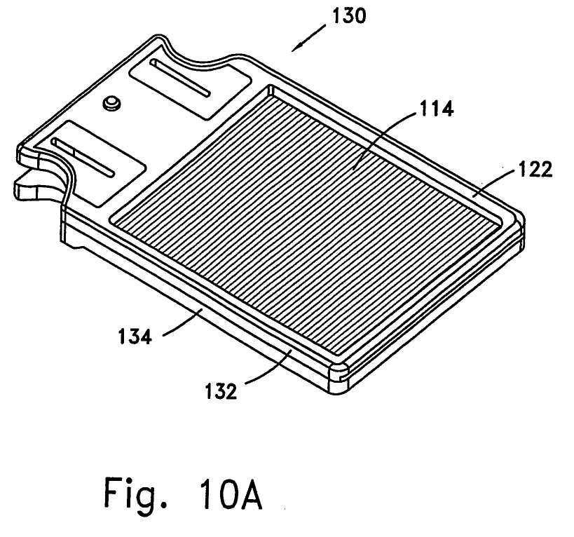

In FIG. 9 is schematically shown a modification of the basic decoder of the invention in which the lenticular panel 114 is surrounded by frame 122. Frame 122 can be held to page 116 by any suitable means, such as simply laying the book on a flat surface and applying a downward force with one or both hands to keep the frame in place during viewing of the images or by using a clamping device such as the familiar “double clips” used to temporarily hold together a collection of loose papers or a clip attached to the rigid frame such as the clip of a conventional clipboard.

An alternate method of achieving alignment is to print a number of reference marks 124 on the page (for simplicity, only two marks are shown in FIG. 9). Suitable alignment aids 126 are provided on the rigid frame 122 of the decoder. The alignment aids 126 can simply be holes through which dots 124 printed on the page can be observed when the correct alignment is achieved. In another embodiment holes are created in the page at locations 124 and pins 126 are located on the bottom side of the rigid frame 22. In yet another embodiment the marks 124 are printed using ink containing metallic particles. In this case the alignment aids can be magnets, which are attracted to the metallic marks and hold the decoder in place. Alternatively, the decoder can have attached to it LEDs that are connected by a circuit that has gaps at locations 126, the circuit being closed and the LEDs lighting when the frame of the decoder is positioned such that conducting elements positioned at 124 fill in the gaps 126 in the circuit.

In most instances, the quality of the images viewed using the arrangement shown in FIG. 7 and FIG. 9 will not be high because the flexible nature of the book is such that the requirement of maintaining the distance between the lenses and printing constant and essentially equal to the focal length is not satisfied, especially if the book is not supported by a tabletop or similar solid surface.

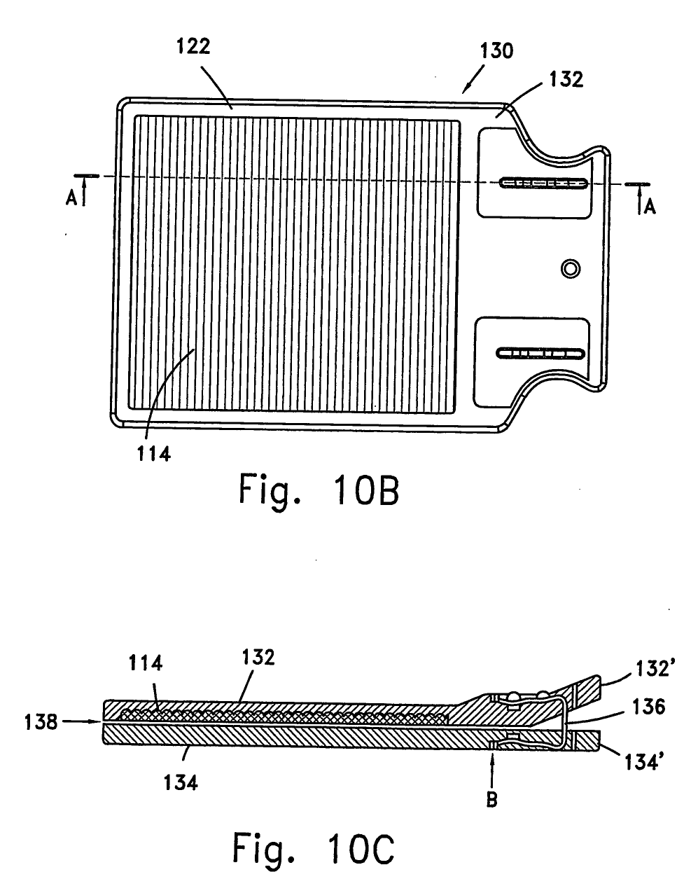

FIGS. 10A to 10C schematically show perspective, top, and cross sectional views of a preferred embodiment of the decoder of the invention that provides a planar, firm surface against which the page and lens sheet is pressed to maintain the proper distance between them. Decoder 130 is comprised of two wings, upper wing 132 and lower wing 134. Lower wing 134 is comprised of a thin rigid solid planar surface. Upper wing 132 comprises a rigid frame 122 surrounding a lenticular panel 114.

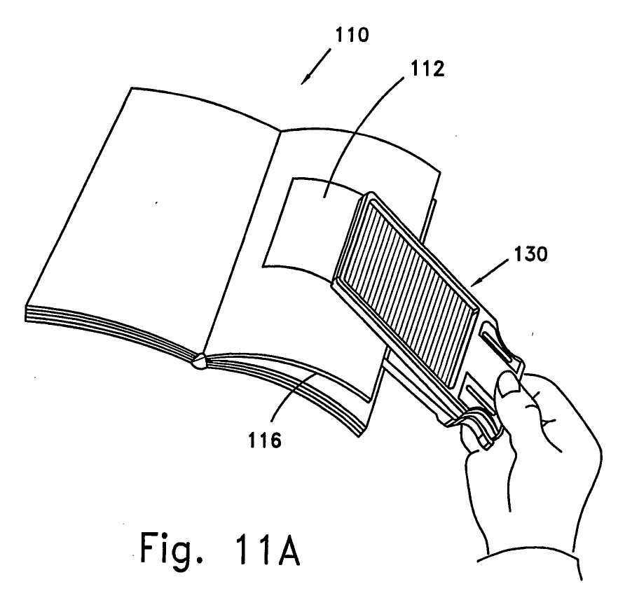

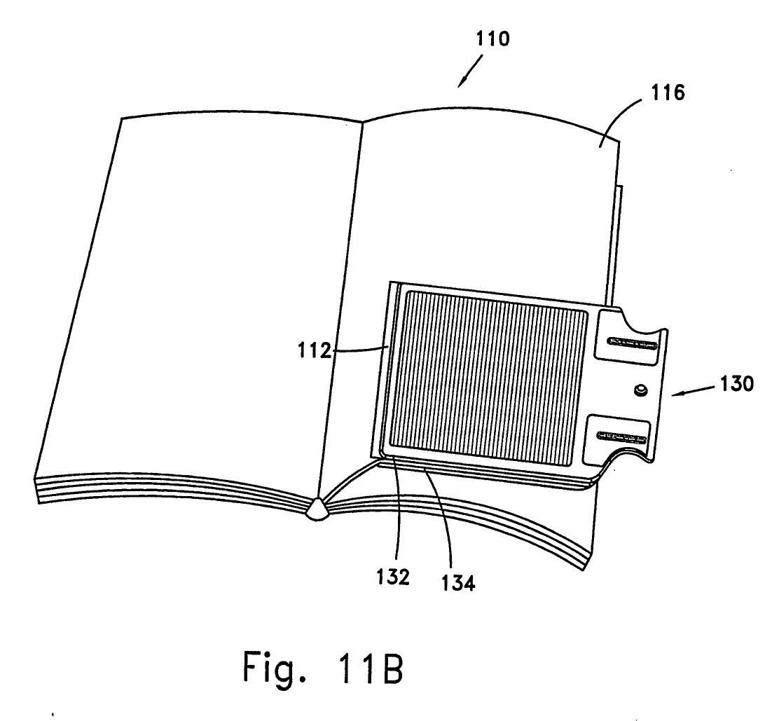

FIGS. 11A and 11B together with FIG. 10C schematically show how the decoder 130 of FIGS. 10A to 10C is attached to the page. The two wings are held in positional relationship to each other by standard arrangements, including springs 136. Pushing the two ends 132′ and 134′ together causes a rotation about an axis located at the position of arrow B. This rotation increases the width of gap 138 enabling a page 116 of book 110 to be slipped between the wings of the decoder. Releasing ends 132′ and 134′, the gap between the wings is closed clamping the decoder to the page. If the decoder is not held tightly enough to the page, the procedure can be repeated and more that one page can be inserted into the gap 138.

Lenticular panel 114 of decoder 130 is aligned with the printing of interlaced image 112 on page 116 by any of the methods described hereinabove.

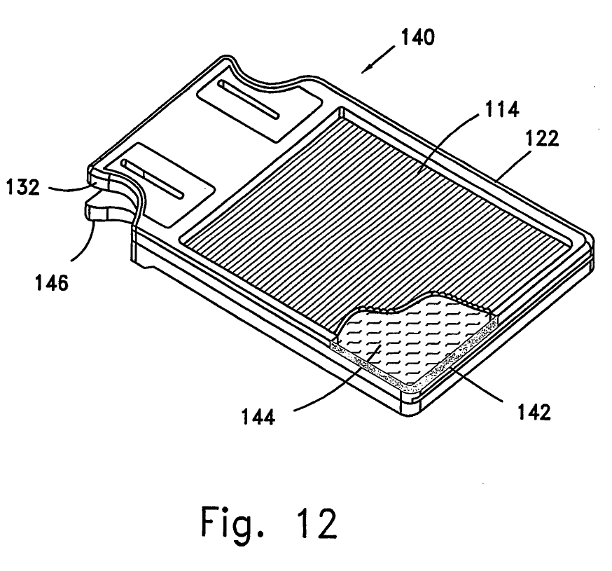

Another embodiment of the decoder 140 is shown in FIG. 12. This embodiment is similar to that of decoder 130 with the exception that the bottom wing 146 is not a smooth, rigid planar surface. In FIG. 12 a part of frame 122 and lenticular panel 114 are cut away to reveal the structure of the lower wing 146. The portion of wing 146 that is underneath the lenticular panel is removed to create a raised rim 142. In the depression inside the rim is placed a resilient mat 144. When the two wings are closed, the mat pushes the page firmly against the lower surface of the lenticular plate. The function of the resilient mat is especially important since, generally, the lenticular panel is not perfectly planar although the thickness of the panel from the top of the lens to the bottom of the plate at any given point is normally essentially constant. The resilient mat causes the print to be in contact with the bottom surface of the lenticular sheet at all points, compensating for localized variations from planarity of the lenticular sheet and establishing and maintaining the required distance between the print and the lens at all locations.

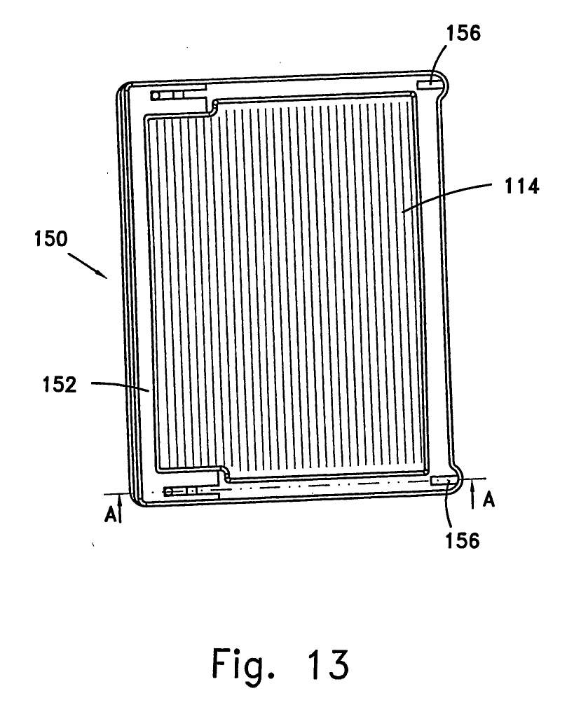

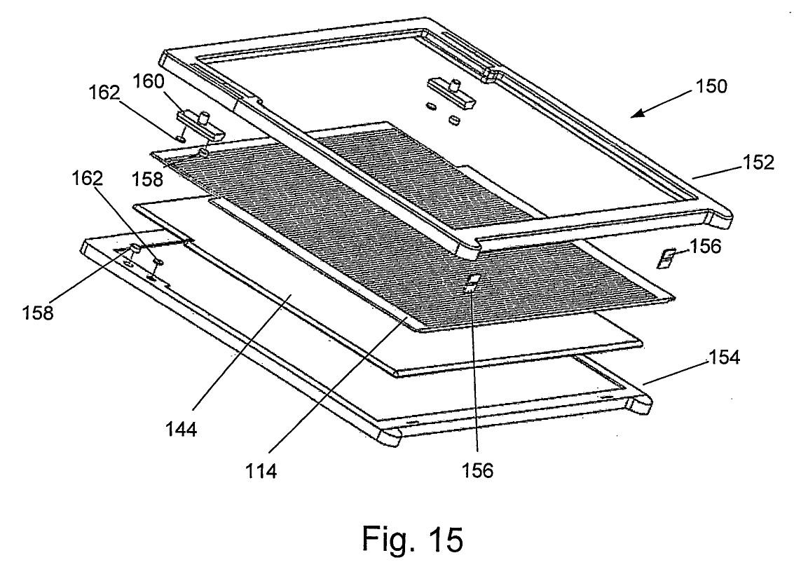

In FIGS. 13, 14A, 14B, and 15 are schematically shown a preferred embodiment of the decoder 150 of the invention. This embodiment of the decoder provides means for attaching itself to the page. The decoder 150 comprises two frames—upper frame 152 and lower frame 154—connected by two hinges 156 (best seen in the exploded view, FIG. 15). The upper frame 152 includes a lenticular panel 114. The lower frame 154 comprises a resilient mat 144 for pressing the page 116 of the magazine or book against the rear face of the lenticular panel 114.

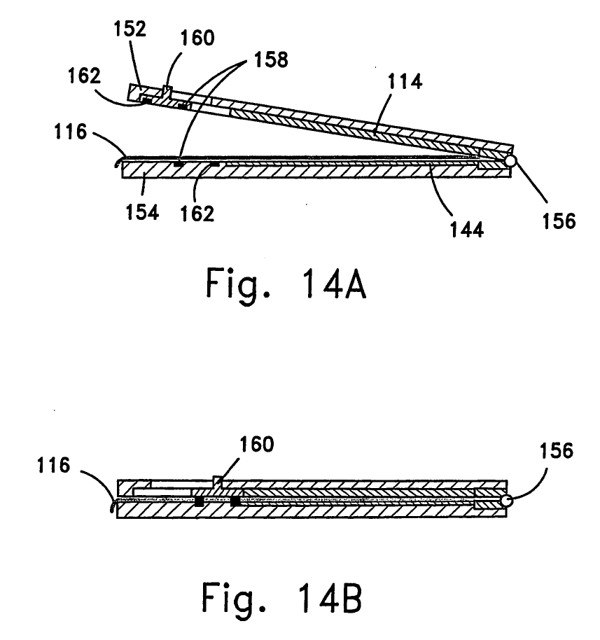

FIGS. 14A and 14B are cross sectional views along A-A (see top view, FIG. 13) showing the decoder in the open position and in the closed position respectively.

The arrangement for keeping the frame in the open or closed position is based on the attraction and repulsion force of the magnets 158. They are arranged in two pairs situated, one pair on each side of the decoder. One magnet of each pair is on the lower frame 152 and one on a sliding element 160 in the upper wing, oriented such that the repulsive magnetic force between them tends to force them apart, thus keeping the two wings of the decoder separated, as shown in FIG. 14A. In addition to the magnets 158 there are also complementary iron disks 162. When the sliding elements 160 are moved to the position shown in FIG. 14B, the magnets 158 are attracted to the disks 162, thus keeping the two frames in the closed position, clamping the page between them.

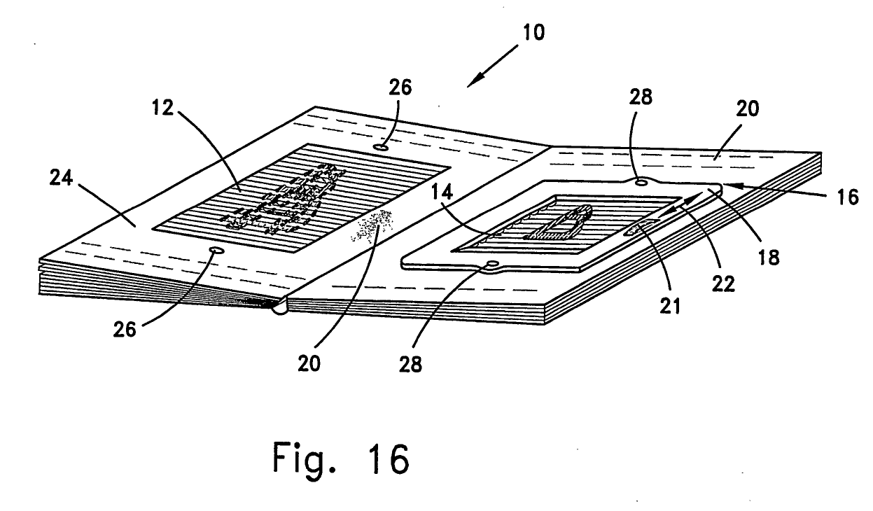

The basic embodiment of the invention for providing a dynamic display is schematically shown in FIG. 16. Printed on the pages 24 of book 10 are interlaced images 12. The interlaced images can be the size of an entire page or smaller, in which case they are printed on the page together with conventional text and illustrations 20, if desired. The basic images of which interlaced image 12 is comprised can be, for example, pictures of different objects, describe the steps in a process, or be the frames of an animated presentation. Decoder 16 comprises a frame 18 surrounding lenticular panel 14, which is. placed over interlaced image 12, which is printed on the page of book 10. Moving knob 21 in the direction shown by the double-headed arrow 22 causes panel 14 to move relative to the rigid frame 18 and therefore, if the frame is firmly attached to the page relative to the printed interlaced image to achieve the desired display.

Frame 18 can be attached to a single page or a group of pages by any suitable means, such as simply laying the book on a flat surface and applying a downward force with one or both hands to keep the frame in place during viewing of the images or using a clamping device such as the familiar “double clips” used to temporarily hold together a collection of loose papers or a clip attached to the rigid frame such as the clip of a conventional clipboard.

As in the case of the embodiments shown in FIG. 7 and FIG. 9, the quality of the images viewed using the arrangement shown in FIG. 16 will frequently not be high because the flexible nature of the book is such that the requirement of maintaining the distance between the lenses and printing constant and essentially equal to the focal length is not satisfied, especially if the book is not supported by a tabletop or similar solid surface.

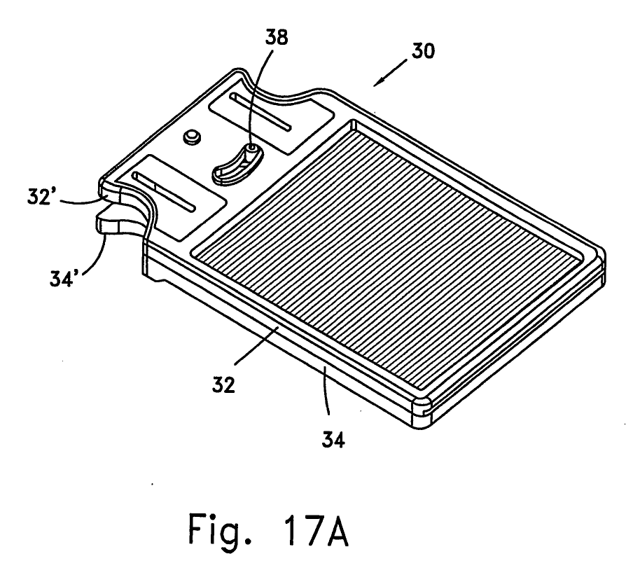

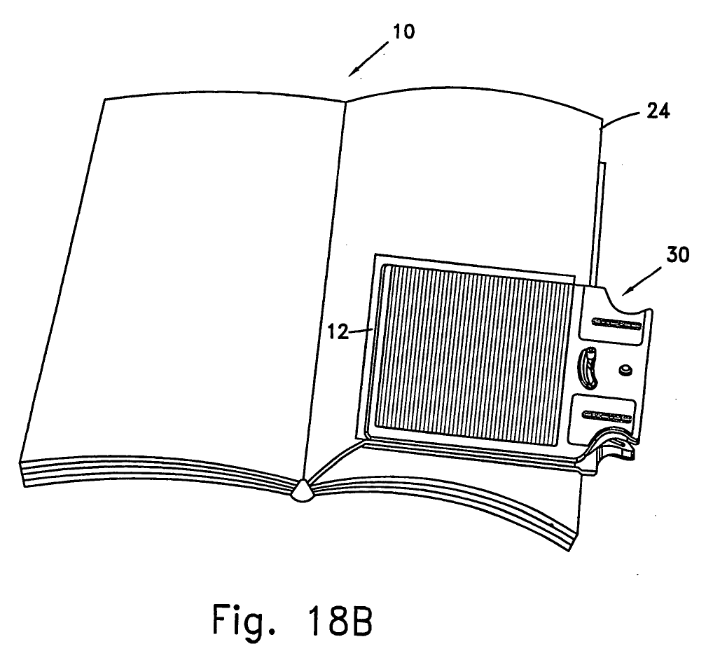

FIGS. 17A to 17C schematically show perspective, top, and cross sectional views of a preferred embodiment of the decoder of the invention that provides a planar, firm surface against which the page and lens sheet is pressed to maintain the proper distance between them. Decoder 30 is comprised of two wings, upper wing 32 and lower wing 34. Lower wing 34 is comprised of a thin rigid solid planar surface. Upper wing 32 comprises a rigid frame 36, a lenticular panel 14, and a mechanism for causing the lenticular panel to move relative to the rigid frame. The mechanism for moving the lenticular panel is not shown in the figures. It could be, for example, similar to that shown in FIG. 21 such that pushing lever 38 would cause gears to engage and turn resulting in the motion of panel 14.

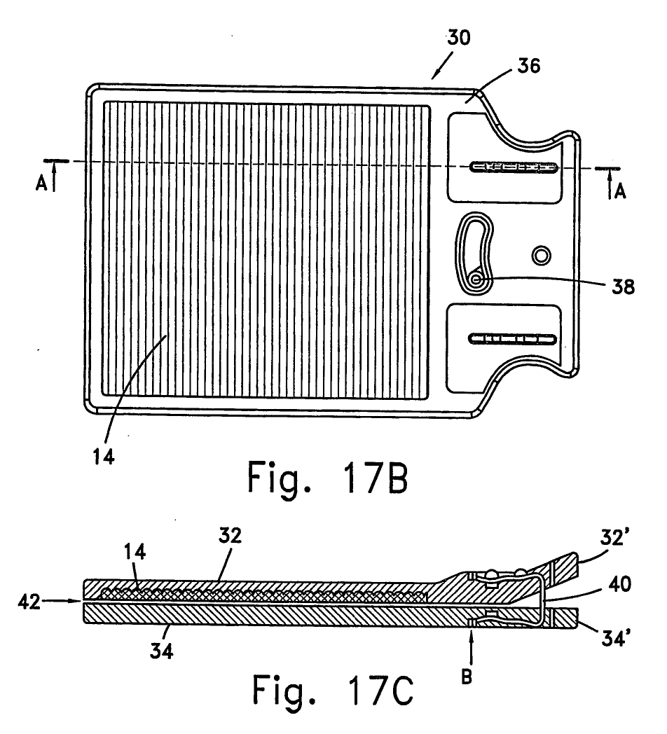

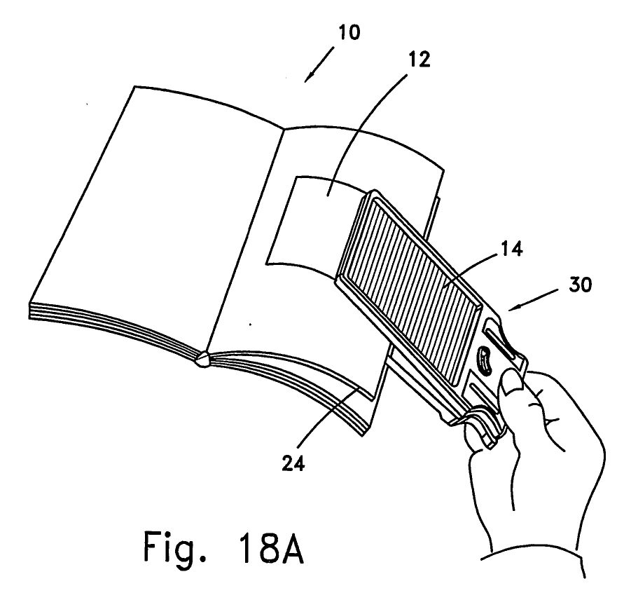

FIGS. 18A and 18B together with FIG. 17C schematically show how the decoder of FIGS. 17A to 17C is attached to the page. The two wings are held in positional relationship to each other by standard arrangements, including springs 40. Pushing the two ends 32′ and 32′ together causes a rotation about an axis located at the position of arrow B. This rotation increases the width of gap 42 enabling a page 24 of book 10 to be slipped between the wings of the decoder. Releasing ends 32′ and 32′, the gap between the wings is closed clamping the decoder to the page. If the decoder is not held tightly enough to the page, the procedure can be repeated and more that one page can be inserted into the gap 42.

Lenticular panel 14 of decoder 30 is aligned with the printing of interlaced image 12 on page 24 by the use of guide lines printed on the page for this purpose or other reference marks and alignment means as discussed with reference to FIG. 7.

Another embodiment of the decoder is shown in FIG. 19. This embodiment is similar to that of FIGS. 17A to 17C with the exception that the bottom wing 34 is not a smooth, rigid planar surface. In FIG. 19 a part of the frame of upper wing 32 and lenticular panel 14 are cut away to reveal the structure of the lower wing 34. The portion of wing 34 that is underneath the lenticular panel is removed to create a raised rim 44. In the depression inside the rim is placed a resilient mat 46. When the two wings are closed, the mat pushes the page firmly against the lower surface of the lenticular plate. The function of the resilient mat is especially important since, generally the lenticular panel is not perfectly planar although the thickness of the panel from the top of the lens to the bottom of the plate at any given point is normally essentially constant. The resilient mat causes the print to be in contact with the bottom surface of the lenticular sheet at all points, compensating for localized variations from planarity of the lenticular sheet and establishing and maintaining the required distance between the print and the lens at all locations.

In FIG. 20 is schematically shown a book 10 and a decoder 31 according to the present invention. On the pages of book 10 are printed interlaced images 12 composed of two or more basic images as described hereinabove and lines of text 48 and/or conventional illustrations 50. The basic images can, for example, be pictures of different objects, describe the steps in a process, or be the frames of an animated presentation. This embodiment of the decoder is designed to allow dynamic display of the basic images.

Also shown in FIG. 20 is a preferred embodiment of the decoder 31 used to view the basic images. The basic components comprising decoder 31 are: frame 36, comprising two symmetrical wings 32 and 34; two lenticular panels 14 (only one shown in FIG. 10) for allowing the basic images of interlaced images 12 printed exactly on top of one another on opposite sides of the page to be viewed; and knob 52 for causing lenticular panels 14 to move relative to the interlaced images 12 printed on the pages.

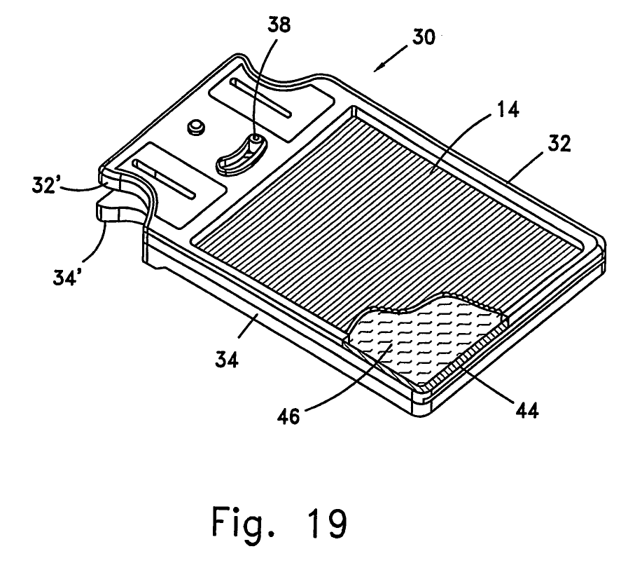

The details of the construction of decoder 31, including those of the means for causing the motion of lenticular panels 14, are more clearly revealed in FIG. 21 and FIG. 22.

The decoder 31 is positioned by slipping the page into the gap 42 between the two wings 32 and 34. The width of gap 42 is determined by the thickness of the paper from which the pages of the book are produced. The width of the gap is such that the natural springiness of the wings will press the lenticular panels firmly against the page. In this way the interlaced image is held in a plane parallel to the panel and the exact optical distance necessary for clearly viewing the basic images is maintained. Additionally the decoder is held in its proper place and orientation relative to the interlaced image.

FIG. 21 is a top view, showing decoder 31 with the upper wing 32 removed in order to reveal internal details of the device. FIG. 22 is a cross sectional view along A-A in FIG. 21. The rigid frame 36 contains transparent lenticular panels 14 with a flat bottom side and an array of horizontal linear lenses on the outer surface. The panels 14 can be moved vertically up and down by manual rotation of knob 52 around its axis 54. Coaxial to knob 52, and permanently attached to it, is gear 56. The teeth on gear 56 engage compatible teeth 58 created on the edge of panel 14 and by means of this gear train the rotation of knob 52 is translated into linear motion of the lenticular panel 14. In all the figures accompanying this description the double headed arrows indicate the direction of motion of the relevant part. In order to reduce friction and also to maintain the proper alignment of the lenses with respect to the printing, two or more wheels 60 are attached to the frame 36 on the side of each panel 14 opposite to the knob 52. Wheels 60 can be smooth as shown in the figures or can be gearwheels that engage teeth created on the edge of the panel in a similar manner to the relationship between gear 56 and teeth 58.

The two symmetrical wings 32 and 34 of the frame 36 are connected by means of screws (not shown) that pass through the bosses 62. The bosses 62 also serve to stop the insertion of the page of the book at a well defined location. The pages of the book are precisely cut with respect to the alignment of the printed lines of the interlaced image.

Thus, the edge of the page becomes a line of reference which, upon contacting the bosses 62, assures alignment of the moving lenses with the printing.

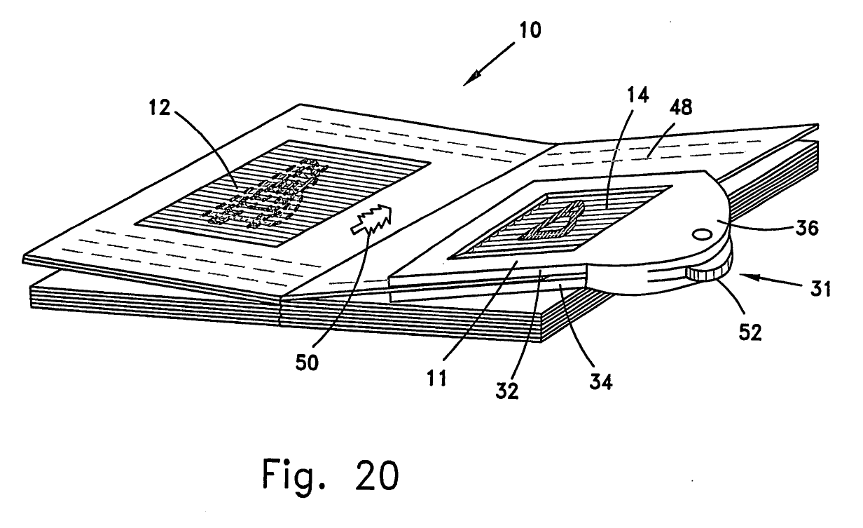

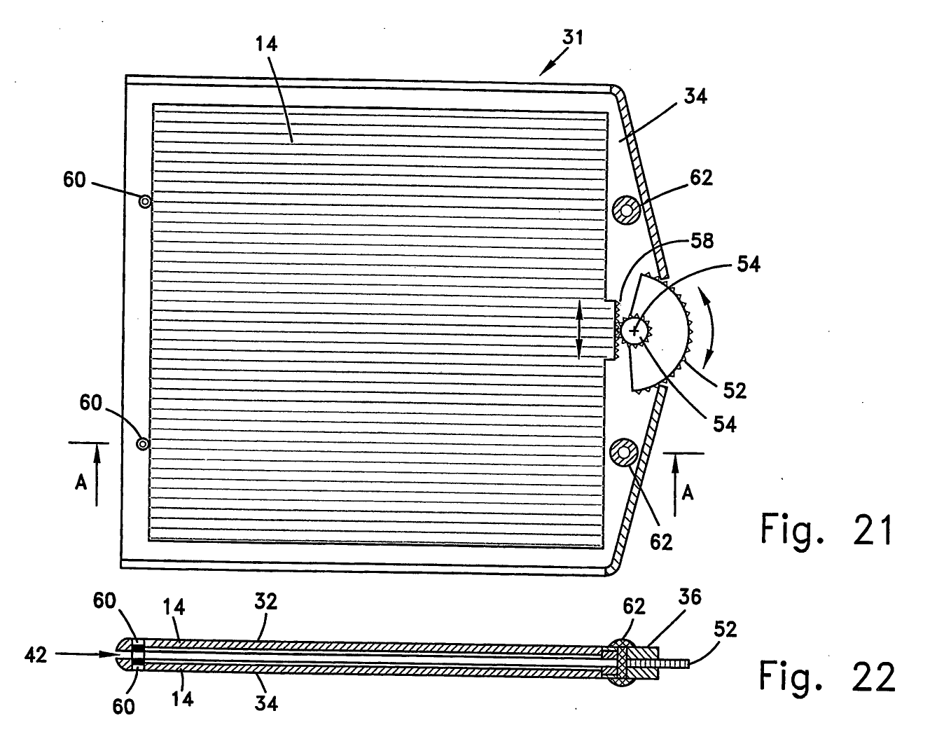

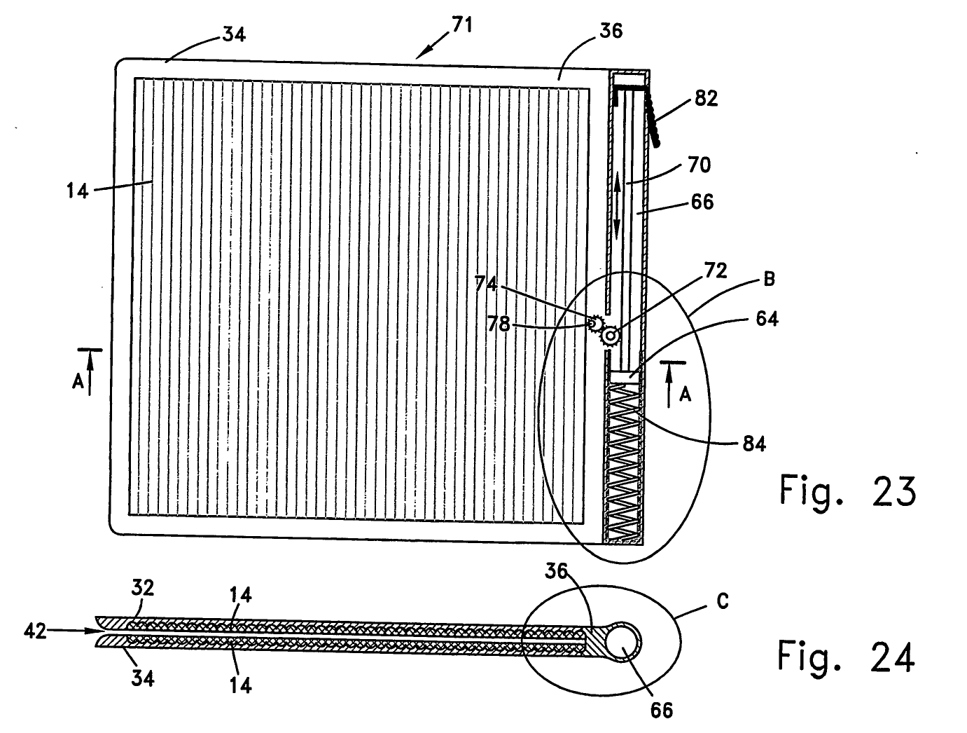

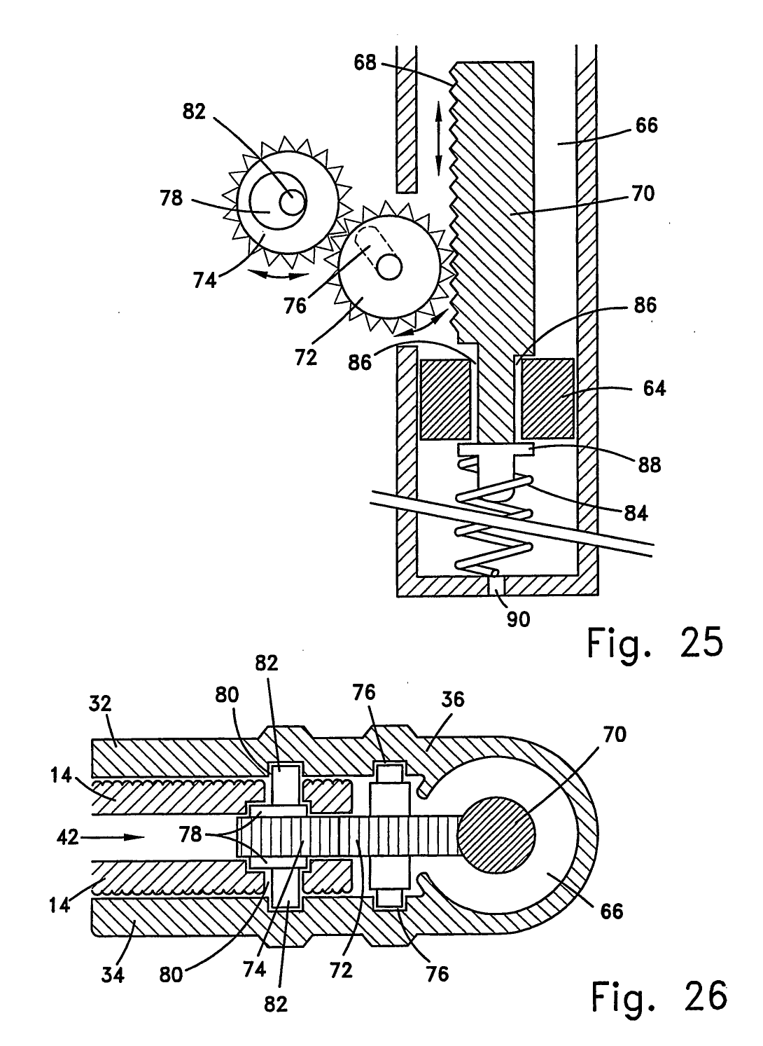

Another preferred embodiment of the decoder device of the invention is schematically shown in FIGS. 23 to 26. This embodiment of the decoder is similar to an embodiment described hereinabove, but additionally comprises a time-release mechanism that, when actuated, automatically causes uniform motion of the lenses relative to the printing of the interlaced image. FIG. 23 is a top view, showing decoder 71 with the upper wing 32 removed in order to reveal internal details of the device. FIG. 24 shows a cross sectional view along A-A in FIG. 23. FIGS. 25 and 26 are enlarged views of selected sections of FIGS. 23 and 24.

The rigid frame 36 contains transparent lenticular panels 14 with a flat bottom side and an array of vertical linear lenses on the top surface. With the page of the book inserted into the gap 42 between the two wings 32 and 34 of rigid frame 36 and clamped by the natural springiness of the wings, the lenticular panels 14 have to be moved back and forth horizontally relative to the frame 36 (and thus the vertical lenses move relative to the vertical lines of print of the interlaced image) in order to view the basic images.

The time-release mechanism for actuating the lens sheets 14 comprises a miniature piston 64 moving within cylinder 66. A plurality of fine teeth 68 (seen in FIG. 15) are created on a portion of the surface of shaft 70 which is connected to piston 64. A first gearwheel 72 engages teeth 68 and also engages second gearwheel 74. When shaft 70 is moved, its linear motion is transformed to rotational motion of gearwheel 74 by means of first gearwheel 72.

The axis of the first gearwheel 72 is received in the small linear recess 76 located in the front and back walls of the rigid frame 36 in a way that the gearwheel 72 can be moved along the recess while rotating around its axis. When the shaft 70 moves upwards, gearwheel 72 engages gearwheel 74 and transmits the rotational motion. When shaft 70 moves downwards, gearwheel 74 is disengaged from gearwheel 72 and therefore does not rotate.

Gearwheel 74 comprises eccentric pins 78 and axis 82 fixedly located on its top and bottom faces. The free ends of axis 82 pass through complementary recesses 80 located in the top and bottom lenticular panels 14 (see FIG. 25). As gearwheel 74 rotates, the eccentric pins 78 periodically displace the lenticular panels 14 relative to the rigid frame 36 which is firmly attached to the page.

In order to actuate the viewing means, a lateral knob 82 connected to the upper part of shaft 70 is pushed downwards, thus compressing spring 84 located in the lower part of cylinder 66. Releasing the knob 82 allows the spring 84 to expand. Expansion of spring 84 pushes shaft 70 upward, engaging and rotating gearwheels 72 and 74 and causing periodic displacement of the lenticular panels 14 as described hereinabove.

The air-volume within the lower part of cylinder 66 is utilized to provide and regulate the time-released movement of shaft 70. The piston 64 (best seen in FIG. 25) is elastic, i.e. made of, for example, rubber or a resilient plastic polymer, and forms an air-tight seal with the smooth interior walls of cylinder 66 while sliding up and down. Shaft 70 is designed such that when pushing the piston 64 against the spring 84, the air in the lower part of cylinder 66 is free to escape cylinder 66 by flowing through gaps 86 between the piston 64 and the shaft 70. When the pushing force ceases, the expanding spring 84 pushes up on the piston 64 and presses flange 88, on the lower part of shaft 70, against the bottom of piston 64 thereby, closing the bottoms of gaps 80. In this situation, unless air is allowed to enter the lower part of cylinder 66, the pressure below the piston decreases as the piston moves up until the pressure difference between the top and the bottom sides of piston 64 is great enough to prevent further upward movement of shaft 70. By creating a narrow passageway 90 through the bottom of cylinder 66, it is possible to control the flow rate of air entering the lower part of cylinder 66, thus maintaining a fixed imbalance of the air pressure on the two sides of piston 64 and allowing the controlled upward motion of shaft 70.

A time release mechanism has thus been created to continually displace the lenticular panels 14 relative to the rigid frame 36 and consequently relative to the interlaced print of the book. Passageway 90 can either be equipped with a valve to allow adjustment of the air flow and therefore adjustment of the viewing rate of the basic images, or can be without a valve allowing viewing at a predetermined fixed rate. The experienced person will also be able to adjust the pitch of the teeth on the gears in order to control the number of basic images that are viewed per activation of the viewing means. This embodiment is especially useful for use for displaying animated sequences in which the interlaced image typically comprises 12 to 24 basic images and in which uniform flipping from basic image to basic image is important to obtain the most effective display.

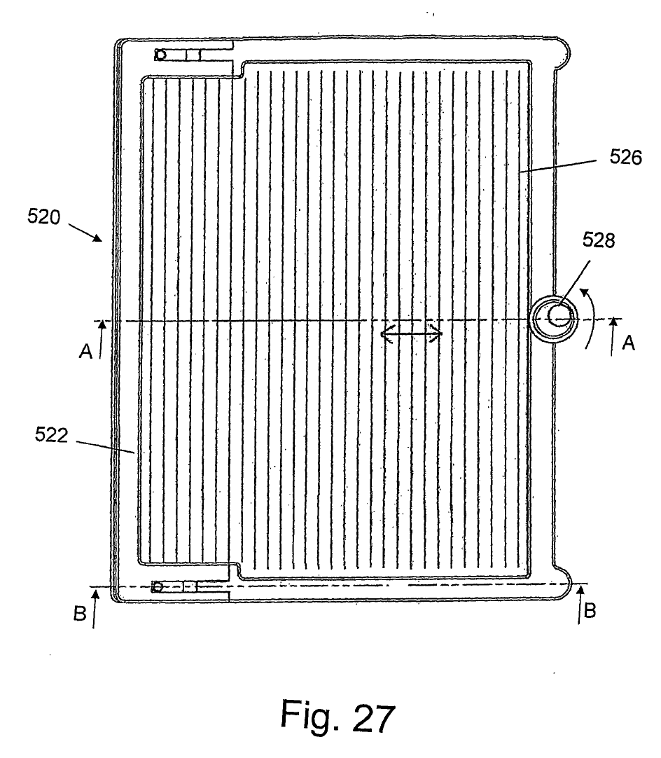

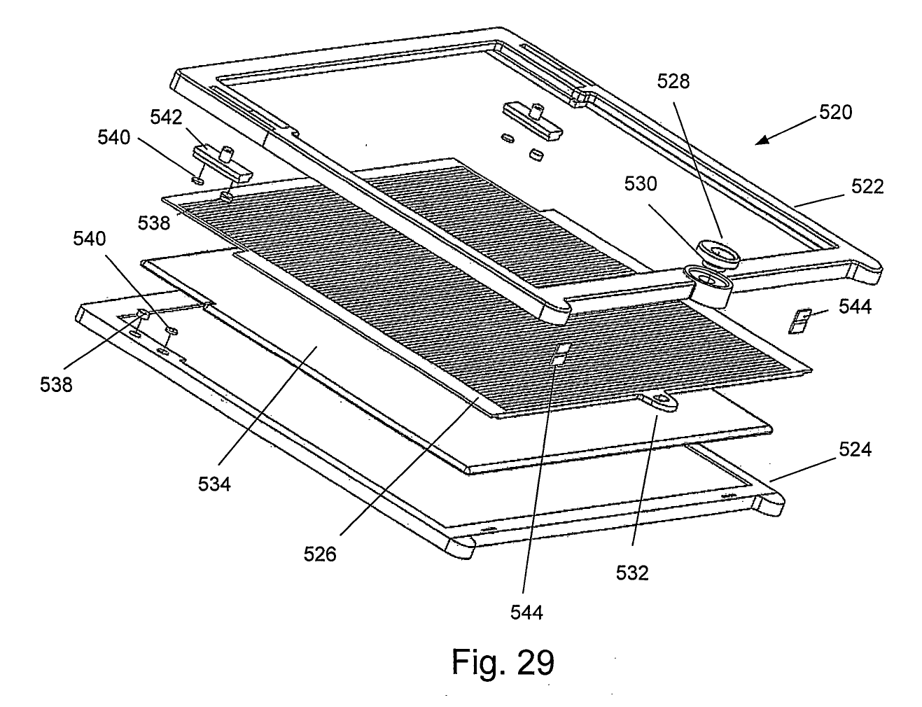

In FIGS. 27, 28A to 28D, and 29 are schematically shown another preferred embodiment of the decoder of the invention. This embodiment of the decoder provides means for moving the lenticular sheet relative to the print and also for attaching itself to the page. The decoder 520 comprises two frames—upper frame 522 and lower frame 524—connected by two hinges 544 (best seen in the exploded view, FIG. 29) The upper frame 522 includes a lenticular panel 526 capable of being periodically horizontally displaced. In order to displace the panel 526, the reader rotates the round knob 528 with his finger. The lower part of knob 528 is an eccentric pin 530, received into a slot 532 in the lenticular panel 526. The lower frame 524 comprises a resilient mat 534 for pressing the page 536 of the magazine or book against the rear face of the lenticular panel 526.

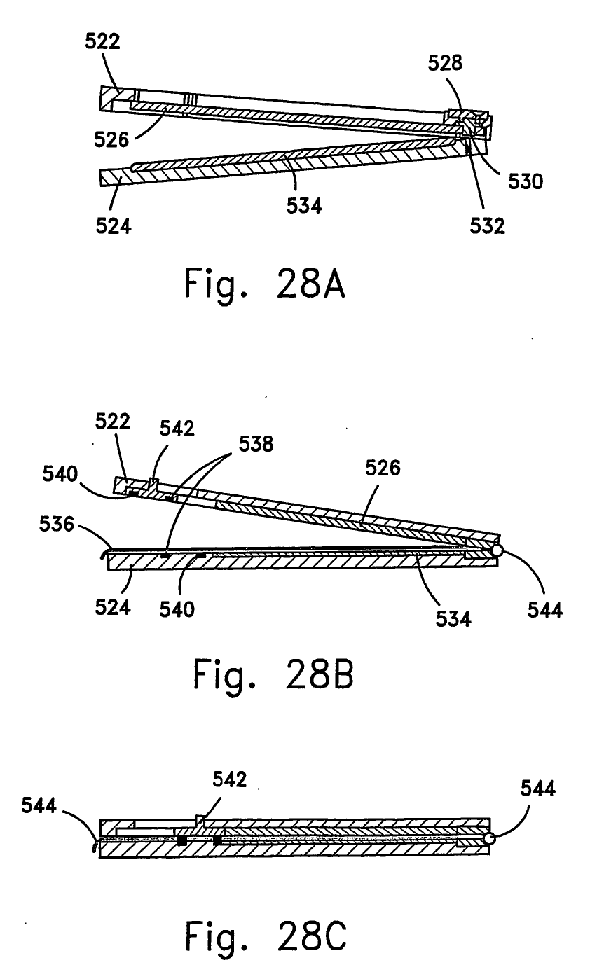

FIGS. 28A and 28B are cross sectional views along A-A and B-B respectively (see, top view, FIG. 27) showing the decoder in the open position. FIG. 28C is a cross sectional view along B-B (see. FIG. 27) showing the decoder in the closed position.

The arrangement for keeping the frame in the open or closed position is based on the attraction and repulsion force of the magnets 538. They are arranged in two pairs situated, one pair on each side of the decoder. One magnet of each pair is on the lower wing 524 and one on a sliding element 542 in the upper wing, oriented such that the repulsive magnetic force between them tends to force them apart, thus keeping the two wings of the decoder separated. In addition to the magnets 538 there are also complementary iron disks 540. When the sliding elements 542 are moved to the position shown in FIG. 28C, the magnets 542 are attracted to the disks 540, thus keeping the two frames in the closed position, clamping the page between them.

FIGS. 30A, 30B, and 30C are top, cross-sectional, and exploded views, respectively, showing schematically a preferred embodiment of the decoder of the invention comprising means for slidably displacing the lenticular panel over the interlaced image. The decoder 550 comprises lenticular panel 552 and displacement means to slidably displace the panel preferably. The displacement means preferably comprise roller means 556. The roller means comprise a rotatable axis 558 supported by two supports 560 at its extremities and provided with contact points 562 on its surface to create a friction with the surface of the pages upon rotation.

The decoder is placed on the interlaced image in the book and aligned as discussed hereinabove. The axis 558 is then rotated slightly (essentially rocked back and forth) and, as a result of the frictional force between the attached contact points 562 and the underlying page, the panel will be displaced relative to the interlaced image and the basic images will be sequentially revealed.

The contact points are made of a high-friction material and can be, for example, ring-like in shape or non continuous protrusions on the axis.

It is preferred that the roller means be actuatable by hand, preferably by the pressure of a finger.

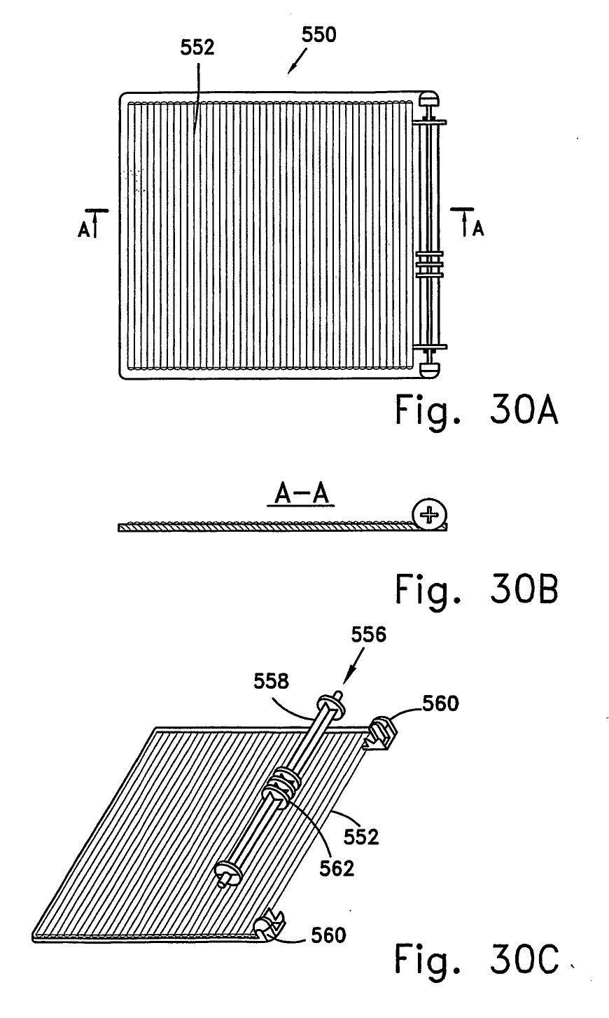

In FIG. 31 is shown schematically a page 302 of bound printed matter such as a book or magazine according to the present invention. On page 302 is printed at least one interlaced image 304 and optionally standard illustrations 306 and lines of text 308. At least one edge, 309 of all of the pages 302 of the bound printed matter must be straight. Edge 309 is preferably the edge of the page opposite and parallel to the binding of the printed matter, although either of the other two edges of the pages can be the straight edge 309 used for the purposes of the invention.

It is to be understood that, although the invention is described herein in terms of interlaced images printed on the pages of bound printed matter, the invention applies to interlaced images that are printed on any suitable surface or indicia carrier. In the context of the present invention, a surface or indicia carrier is “suitable” if, in addition to the normal requirements, it has at least one straight edge suitable for guiding the motion of the decoder of the invention as described hereinbelow.

The interlaced image 304 is created and printed on page 302 by any of the methods known to persons skilled in the art of lenticular displays.

The special requirement of the present invention is that the lines of print of the interlaced image be printed slanted at a given angle relative to edge 309 of the page. In the preferred embodiment shown in the figures, the angle is ninety degrees.

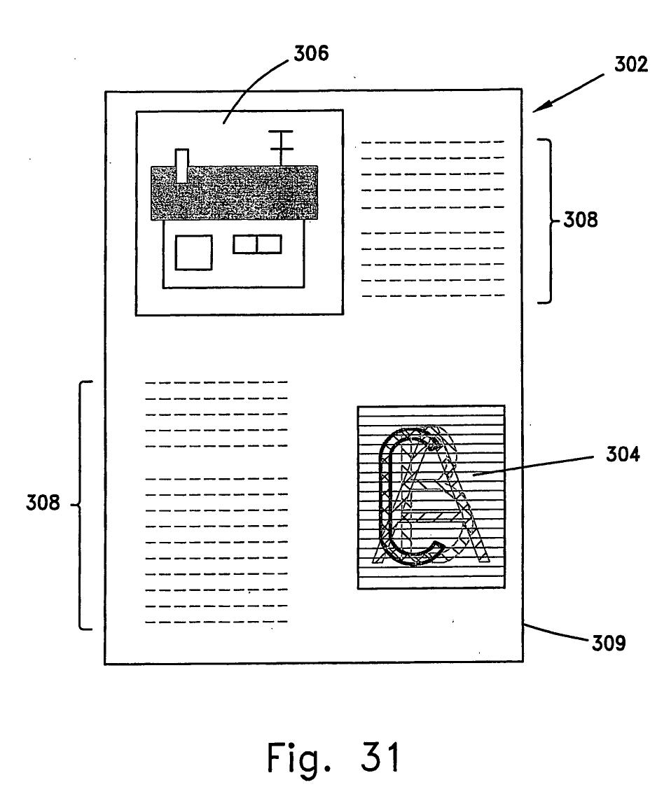

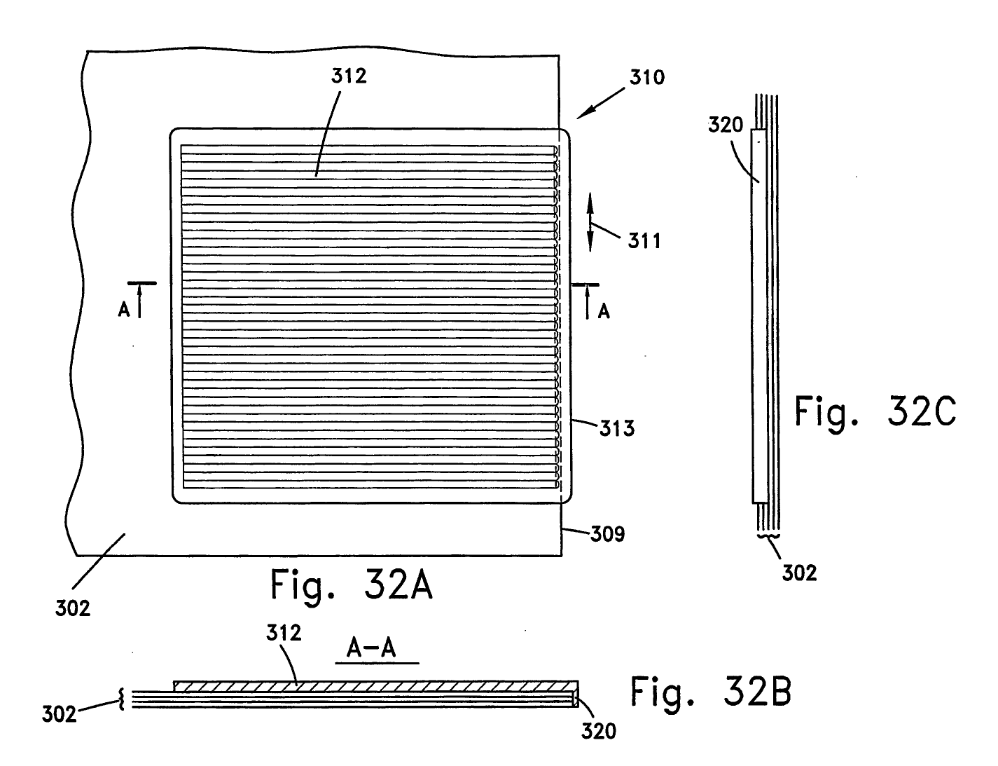

FIGS. 32A, 32B, and 32C are top, cross-sectional, and side views, respectively, showing schematically a preferred embodiment of a decoder of the invention which is capable of being slidably displaced with respect to the interlaced image. The decoder 310 comprises lenticular panel 312 and means for establishing and maintaining the required alignment between the interlaced image and the lenticular panel.

In this embodiment, lenticular panel 312 has an array of cylindrical lenses on the top surface and a planar bottom surface. According to the invention, the alignment means comprise one or more contact surfaces located along the length of the outer edge of the lenticular panel and projecting downward from its lower surface. The contact surfaces can be fixed, as shown in the figures, or any other suitable arrangement of static or moving surfaces including, but not limited to a set of pins, rotatable cylinders or wheels. In the preferred embodiment of the invention shown in the figures, the alignment means comprise a lip 320 running along the length of outer edge 313 of panel 312 and projecting downward from the planar bottom surface. Henceforth only embodiments employing a lip will be described but it is to be understood that the invention can be carried out using contact surfaces of all types. Lip 320 can be formed from a single long strip, broken-up into two or more tabs, or any equivalent arrangement to maintain the alignment of the panel with edge 309 of the page, as described hereinbelow.

Edge 313 of the panel and the inner edge of lip 320 are straight and parallel such that, when the decoder 310 is laid on page 302 as shown in FIG. 32A, edge 309 is parallel to and in contact with the inner edge of lip 320. The lenses are oriented on the top surface of lenticular panel 312 such that their long symmetry axes are slanted with respect to edge 313 at the same given angle as the lines of print of the interlaced image are printed relative to edge 309 of the page. Therefore the lenses are parallel to the lines of print of the interlaced image. The pitch of the lenses is equal to the width of the printed lines of the interlaced image and the thickness of the panel is equal to the focal length of the lenses, thus satisfying the first two requirements for viewing a lenticular display listed hereinabove. The lip 320 which, if kept pressed against edge 309 while decoder 310 is slid up and down in the direction shown by double headed arrow 311, guides the motion of the lenticular panel relative to the interlaced image and insures that the third requirement is satisfied. Since all of the required conditions are met, a dynamic lenticular display is achieved.

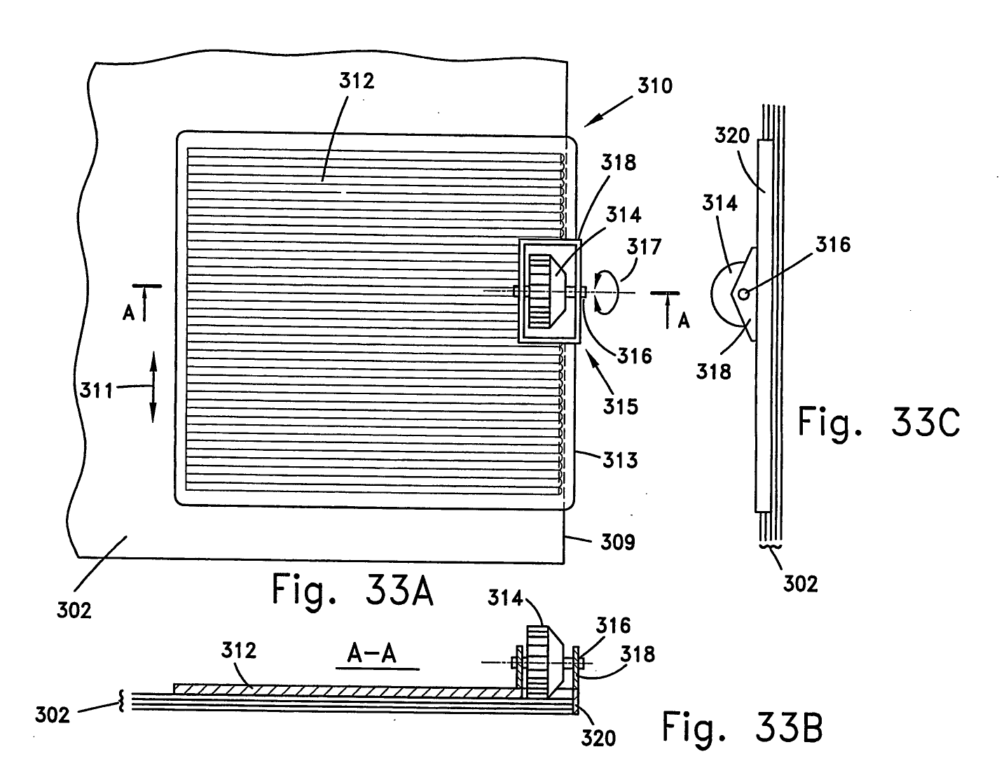

FIGS. 33A, 33B, and 33C are top, cross-sectional, and side views, respectively, showing schematically a preferred embodiment of a decoder of the invention additionally comprising means for slidably displacing the lenticular panel over the interlaced image. In the preferred embodiment of the invention, the displacement means 315 are roller means comprising a wheel 314 attached to rotatable axis 316 and supported by supports 318 at its extremities. The axis 316 can also be fixed with wheel 314 rotating about it. Wheel 314 has a diameter such that, when decoder 310 is laid on page 302, the outer circumference of the wheel 314 is in contact with the surface of the page. The edge of wheel 314 in contact with page 302 is provided with a suitable outer surface such as rubber or an array of small protrusions such that, upon rotation of wheel 314, a frictional force is created between the wheel and with the surface of the page.

The decoder is placed over the interlaced image on the page and pushed against the book so that lip 320 is in contact with the edge of the pages. Since edge 309 of the page and the inner edge of lip 320 are both straight and are parallel to each other, the lines of print of the interlaced image are orthogonal to edge 309, and the axes of the lenses are orthogonal to the inner edge of lip 320, it follows that the proper alignment between the lines of print and the lenses has been achieved.

The wheel 314 is then rotated slightly (essentially rocked back and forth) as indicated by double headed arrow 317. As a result of the frictional force between the edge of the wheel and the underlying page, the panel is displaced relative to the interlaced image, as indicated by arrow 311, and the basic images are sequentially revealed. Pressing lip 320 against the edge of the page 309, while rotating wheel 314, insures that the proper alignment is maintained.

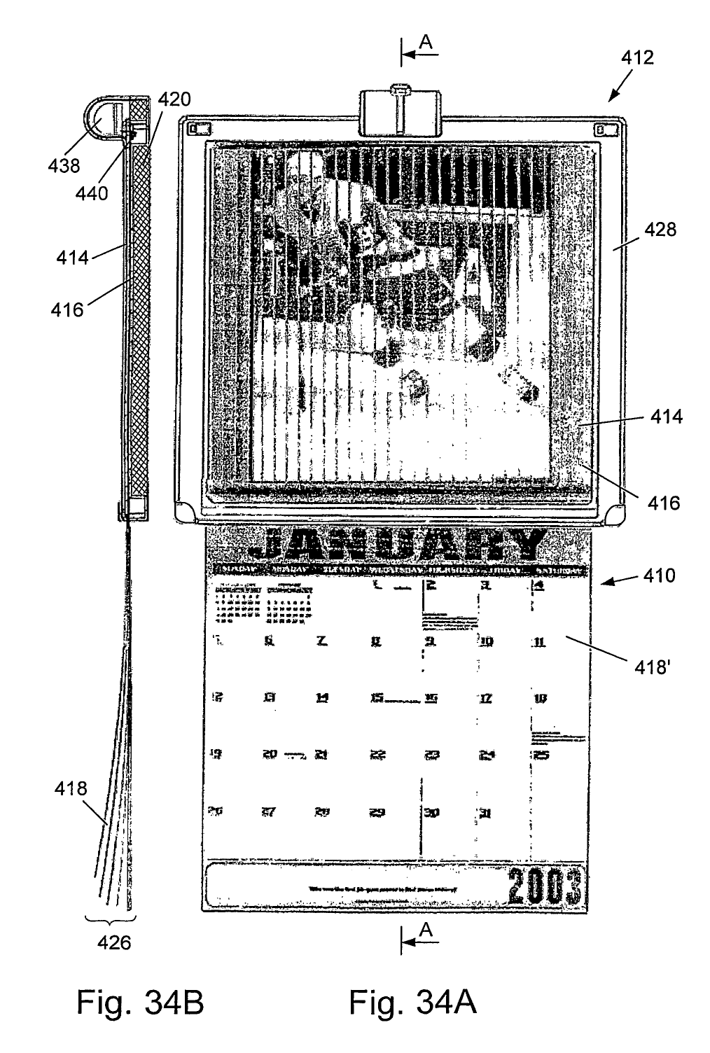

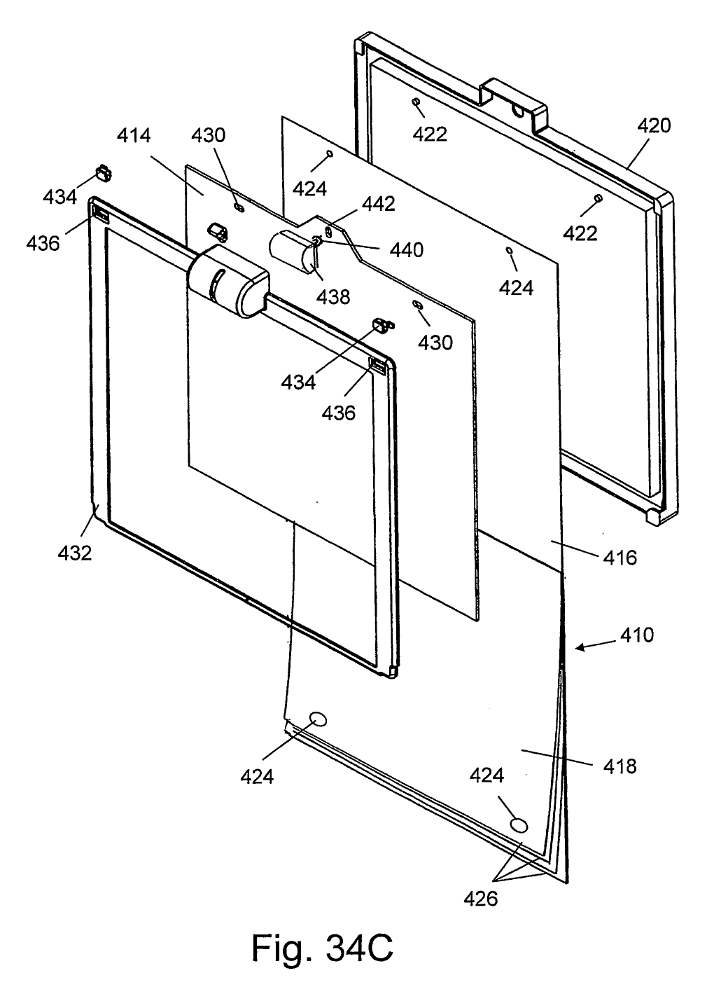

In some embodiments of the present invention, the printed matter is in the form of a wall calendar. These embodiments are described with reference to the illustrative but not limitative embodiment shown schematically in FIGS. 34A to 34C. These figures show, respectively, front, cross-sectional, and exploded views of the calendar 410 and decoder 412 of the invention.

Calendar 410 is produced like a book with the exception that the printing and images are oriented parallel to the spine and not perpendicular to it as in conventional books. With the calendar hung on the wall, the top page 416 comprises the images that are to become the changing display and the lower page 418 comprises the printed matter (dates, days of week, etc.) that are not part of the static or dynamic display. On the back side of page 418 is printed another image which appears on the top when the page is turned for the next month. In another embodiment the calendar is printed on a single large sheet of paper comprising a single image on its top and a number of pages, containing the dates, etc., stapled or glued to its lower half. The old page is torn off to reveal the information relative to the present time period. Although in this specification the calendar is always referred to as being hung on or attached to a wall, it should be clear that the use, in this context, of the word “wall” refers to any substantially vertical surface.

An optical device, referred to for simplicity as a decoder 412, is provided to decode the masked images, i.e. to allow the basic images comprising the interlaced image to be individually observed. The principal component of the decoder is a lenticular panel 414. Decoder 412 comprises elements used to view the basic images that comprise the interlaced images as well as means for holding the calendar 410 and establishing and maintaining the distance and orientation between lenses and print required for a lenticular display.

Decoder 412 comprises a back part 420 which is attached to the wall by suitable means such as screws or hooks. Two pins 422 protrude in a direction perpendicular to the wall from the front side of back part 420. Two holes 424, suitable for slipping over pins 422 are created in the pages of calendar 410. Holes 424 are created in the pages of the calendar such that the line that connects them is as close as possible to perpendicular to the lines of print of the interlaced image. The page 416 is hung from pins 422 with the lenticular image facing forward and the rest of the pages 426 of the calendar, including page 418 hanging below the frame 428 of decoder 412.

Lenticular lens panel 414 is constructed from a transparent planar sheet and has a planar back surface and a vertical array of cylindrical lenses on its front surface. In a preferred embodiment of the invention, the front surface of the lenticular sheet is coated with an antireflection layer in order to allow improved viewing of the images. Lenticular lens panel 414 is attached to the decoder 412 and held in place over the interlaced images on page 416, by means of horizontal slots 430 that fit over pins 422. The slots 430 are created through lenticular panel 414 such that the line that connects them is as close as possible to perpendicular to the axis of the lenses, thus assuring alignment of the lenses and lines of print. The thickness of lenticular lens panel 414 is essentially equal to the focal length of the lenses and thus the required distance between lenses and print is established and maintained when the front part 432 of decoder 412 is attached and fastened to the back part 420.

Finally the front part 432 of the decoder 412 is fastened in place by means of fasteners 434 that reach through openings 436 and lock into the back part 420 of decoder 412. The back side of the lenticular panel 414 is pressed into contact with the print on page 416 by the pressure exerted by the frame of the decoder. Generally the lenticular panel is not perfectly planar although the thickness of the panel from the top of the lens to the bottom of the plate at any given point is normally essentially constant. To correct this problem, a resilient mat (not shown in the figures) can be placed between the page on which the images are printed and the back of the decoder. The resilient mat causes the print to be in contact with the bottom surface of the lenticular sheet at all points, compensating for localized variations from planarity of the lenticular sheet and establishing and maintaining the required distance between the print and the lens at all locations.

Located in the upper part of the front part 432 of the decoder 412 is a small motor 438 which has an eccentric cam 440 fixed on its shaft. Cam 440 fits into a slot 442 created in the upper part of lenticular panel 414.

According to the present invention, at least some of the images on the calendar are interlaced images that are printed, using conventional printing techniques, directly on the pages of the calendar. The interlaced image can be essentially the size of the page or smaller than full size, in which case more than one interlaced image can occur on a page or non-interlaced printing can be present covered by areas of the lenticular panel which do not contain lenses, thus allowing the conventional printing to be viewed simultaneously with the moving display.

When the motor is actuated, the rotating cam 440 causes the panel 414 to move back and forth horizontally thus sequentially displaying the basic images. The moving panel is kept properly oriented with respect to the interlaced image by slots 430 and a guide rail (not shown in the figures) at its bottom. The motor 438 can be powered by batteries, solar cells, or mains power and can be activated by a simple on/off switch or by any other means, such as for example a motion or sound activated switch.

The embodiment described hereinabove provides a dynamic display in which the basic images are revealed by the relative motion between the print lines of the interlaced image and the lenses on the lenticular sheet caused by the rotation of the motor. A static display can be achieved by use of an embodiment very similar to that described herein above without a motor, or in fact with the same decoder and not actuating the motor. In either of these cases, the basic images are sequentially viewed when the observer's angle of vision through the lenticular sheet is shifted, such as would occur by walking past the calendar.

The creation of a changing display, using interlaced images printed on the calendar, i.e. in a display that changes as each successive basic image is revealed, can be used to show many pictures at the same location or to give the illusion of motion.

Further aspects of the present invention that are of considerable commercial interest are the protection that it can provide to copyright owners and the ability to prevent viewing of the images by unauthorized persons. The very nature of the interlaced images means that such illustrations can not be photocopied or electronically scanned for reprinting or distribution via the internet, i.e. one of the major causes of financial loss to the printing industry can be virtually eliminated by the method and devices of the present invention. The fact that the images are masked unless decoded with a matching optical device, which can be under the strict control of the owner of the masked images, means the ability to clearly view the images is restricted to authorized viewers only.

Although embodiments of the invention have been described by way of illustration, it will be understood that the invention may be carried out with many variations, modifications, and adaptations, without departing from its spirit or exceeding the scope of the claims.

1.-70. (canceled)

71. Bound printed matter comprising one or more interlaced images printed on one or more pages, said interlaced image(s) comprising two or more basic images, wherein, said basic images are successively viewable by means of a decoder, said decoder comprising at least one lenticular panel, having one planar surface and an array of lenticular lenses on the other surface, wherein said lenticular panel is separate from said printed matter.

72. Bound printed matter according to claim 71, further comprising means for moving said lenticular panel relative to said image.

73. Bound printed matter according to claim 71, wherein the decoder additionally comprises means for aligning the lenticular panel with the interlaced image printed on the page.

74. Bound printed matter according to claim 71, wherein the pitch of the lines of print in at least a portion of the interlaced image is variable.

75. In combination, printed matter comprising one or more interlaced images printed on one or more of its pages, each of said interlaced image(s) comprising two or more basic images, and a decoder for successively viewing said basic images, said decoder comprising at least one lenticular panel, having one planar surface and an array of lenticular lenses on the other surface; wherein said lenticular panel is separate from said printed matter.

76. A combination, according to claim 75, wherein the decoder further comprises means for moving the lenticular panel relative to the image and/or means for aligning said lenticular panel with said interlaced image printed on said page.

77. A combination, according to claim 75, wherein the printed matter further comprises reference marks for alignment created on the pages.

78. A decoder for interlaced images on a page of bound printed matter, said decoder comprising:
at least one lenticular panel, having one planar surface and an array of lenticular lenses on the other surface;
optionally means for moving said lenticular panel relative to said image;
optionally means for aligning said lenticular panel with said interlaced image printed on said page; and
optionally means to hold said decoder to said page;
wherein said lenticular panel is separate from said page.

79. A decoder according to claim 78, further comprising a frame.

80. A decoder according to claim 79, wherein the array of lenses is moveably attached to the frame.

81. A decoder according to claim 80, further comprising means for moving the lenticular panel relative to the frame.

82. A decoder according to claim 78, wherein the array of lenticular lenses is essentially linear.

83. A decoder according to claim 78, wherein the pitch of the lenses on at least a portion of the lenticular sheet is variable.

84. A decoder according to claim 78, further comprising a time-release mechanism for controlling the motion of the lenticular panel relative to the rigid frame.

85. A decoder according to claim 78, comprising means to slidably displace the lenticular panel which comprise roller means.

86. A decoder according to claim 85, wherein the roller means comprise a rotatable axis provided with contact points on its surface to create a friction with the surface of the pages upon rotation, thereby to cause a displacement of said panel.

87. A decoder according to claim 85, wherein the roller means are actuatable by hand.

88. A decoder according to claim 85, wherein the roller means are actuatable by the pressure of a finger.

89. An interlaced image according to claim 70, which is added to a page of a bound printed matter by adding a sticker or by placing the interlaced image on top of a page and/or of an existing image in any other way and by any other means.

90. A sticker comprising an interlaced image.

91. A decoder according to claim 78, further comprising a planar firm surface, wherein the page is inserted between the lenticular sheet and said planar firm surface.

92. A decoder for successively viewing the basic images of which an interlaced image printed on a surface is composed, said decoder comprising:
a. a lenticular panel, having an array of lenticular lenses on at least one surface; and
b. means for establishing and maintaining the required alignment between said interlaced image and said lenticular panel;
wherein said means for establishing and maintaining the required alignment between said interlaced image and said lenticular panel comprise one or more contact surfaces located along the length of the outer edge of said panel and projecting downward from its lower surface, said contact surfaces being selected from static or moving surfaces or a combination thereof.

93. A decoder according to claim 92, wherein the surface is a page of bound printed material.

94. A method of using the decoder of claim 92 to successively view the basic images of which an interlaced image printed on surface is composed, said method comprised of the following steps:
a. placing said decoder over said interlaced image on said surface;
b. pushing said decoder against said surface so that the means for establishing and maintaining the required alignment between said interlaced image and the lenticular panel are in intimate contact with the edge of said surface; and
c. slidably displacing said lenticular panel relative to said interlaced image.

95. A decoder for interlaced images on a page of a wall calendar comprising:
a rigid back part attachable to a substantially vertical surface;
a lenticular panel, having one planar surface and an array of lenticular lenses on the other surface, moveably attached to said back part;
optional means for moving said lenticular panel relative to said back part; and
means for maintaining said lenticular panel in alignment with said lines of print.

96. A decoder according to claim 95, wherein the means for moving the lenticular panel relative to the back part is a motor having an eccentric cam on its shaft.

97. A decoder according to claim 96, wherein the motor is actuated by an energy source chosen from the following group:
a. battery;
b. solar energy; and
c. electric mains power.

98. A decoder according to claim 95, wherein the pitch of the lenses on the lenticular panel is constant.

99. A decoder according to claim 95, wherein the pitch of the lenses on at least a portion of the lenticular sheet is variable.

100. A wall calendar comprising one or more interlaced images printed on its pages, said interlaced images comprising two or more basic images wherein, said basic images are successively viewed by means of a decoder, said decoder comprising:
a rigid back part attachable to a substantially vertical surface;
a lenticular panel, having one planar surface and an array of lenticular lenses on the other surface, moveably attached to said back part;
optional means for moving said lenticular panel relative to said back part;
means for maintaining said lenticular panel in alignment with said lines of print.

101. In combination, a wall calendar comprising one or more interlaced images printed on its pages, said interlaced image comprising two or more basic images and a decoder for successively viewing said basic images, said decoder comprising:
a rigid back part attachable to a substantially vertical surface;
a lenticular panel, having one planar surface and an array of lenticular lenses on the other surface, moveably attached to said back part;
optional means for moving said lenticular panel relative to said back part; and
means for maintaining said lenticular panel in alignment with said lines of print.
